(19) United States
(12) Patent Application Publication
(10) Pub. No.: US 2010/0181137 A1
(43) Pub. Date: Jul. 22, 2010

(54) CLUTCH FOR AUTOMATICALLY ADJUSTING PLAY AMOUNT AND VEHICLE INCLUDING THE SAME

(75) Inventor: Yousuke ISHIDA, Shizuoka-Ken (JP)

Correspondence Address: RABIN & Berdo, PC, 1101 14TH STREET, NW, SUITE 500, WASHINGTON, DC, 20005, US

(73) Assignee: Yamaha Hatsudoki Kabushiki Kaisha, Shizuoka-Ken (JP)

(21) Appl. No.: 12/691,335

(22) Filed: Jan. 21, 2010

(30) Foreign Application Priority Data
Jan. 21, 2009 (JP) 2009-011430

(51) Int. Cl. B60K 5/04; F16D 13/32; F16D 13/75

(52) U.S. Cl. 180/293; 192/70.252; 192/111.12

(57) ABSTRACT

A clutch includes an automatic play adjusting mechanism interposed between a pressure plate and a pull rod, to allow movement of the pressure plate relative to the pull rod in a clutch axial direction in a clutch connected state, and to restrict the movement of the pressure plate relative to the pull rod in the clutch axial direction when the pull rod moves more than a prescribed play amount in the clutch axial direction. As a result, the clutch can restrict the shift of a touch point caused by thermal expansion or wear, and the play amount of the clutch can be adjusted automatically.

### CROSS-REFERENCE TO RELATED APPLICATIONS

This application claims priority under 35 U.S.C. §119 from Japanese Patent Application No. JP 2009-011430, filed Jan. 21, 2009, the entirety of which is incorporated herein by reference.

### BACKGROUND OF THE INVENTION

1. Field of the Invention

Embodiments of the present invention relate to a clutch for automatically adjusting a play amount, and to a vehicle including the clutch.

2. Description of Related Art

Friction clutches have been often used in vehicles or the like as a device that engages and disengages transmission of engine driving force to a driving wheel.

A clutch disclosed by JP 7-190086 A includes a friction plate, a clutch plate, a pressure plate arranged to have the friction plate and the clutch plate pressed against each other upon receiving the pushing force of the clutch spring, and clutch disconnecting means arranged to move the pressure plate against the pushing force of the clutch spring so that the friction plate and the clutch plate are separated from each other. The clutch disconnecting means has a release shaft arranged to pull the pressure plate against the pushing force of the clutch spring, and a lever arranged to rotate the release shaft.

The lever is provided to cause the friction plate and the clutch plate to be separated in a prescribed rotation position (hereinafter referred to as the “touch point”). More specifically, when the lever rotates beyond the touch point, the clutch is disconnected.

### SUMMARY OF THE INVENTION

Embodiments of the present invention provide a clutch capable of automatically adjusting a play amount, and to a vehicle including the clutch.

A clutch according to embodiments of the invention can have a connected state and a disconnected state. The clutch can include a main shaft, a friction plate, a clutch plate, a rod, a pressure plate, a clutch spring, and an automatic play adjusting mechanism. The main shaft can be arranged along a prescribed clutch axial direction. The friction plate can be supported rotatably around the main shaft to rotate according to the rotation of a crankshaft. The clutch plate can be supported around the main shaft and opposed to the friction plate, the clutch plate and the friction plate to rotate together with the main shaft. The rod can be arranged along the clutch axial direction and moved to one side in the clutch axial direction in the disconnected state. The pressure plate can be supported rotatably around the rod. The clutch spring can be arranged to push the pressure plate to the other side in the clutch axial direction so that the friction plate and the clutch plate are rubbed against each other. The automatic play adjusting mechanism can be provided between the pressure plate and the rod to allow the pressure plate to move relative to the rod in the clutch axial direction in the connected state, and to restrict the movement of the pressure plate relative to the rod in the clutch axial direction in the disconnected state. Advantageously, according to embodiments of the invention, a shift, caused by thermal expansion or wear, of a “touch point” of the clutch can be reduced, and a play amount of the clutch can be adjusted automatically.

Other features, elements, steps, characteristics and advantages of the present invention will become more apparent from the following detailed description of embodiments of the invention with reference to the attached drawings.

### BRIEF DESCRIPTION OF THE DRAWINGS

FIG. 1 is a side view of a motorcycle including a clutch according to an embodiment of the invention.

FIG. 2 is a sectional view of an internal structure of a power unit shown in FIG. 1.

FIG. 3 is a sectional view of a clutch according to a first exemplary embodiment of the invention.

FIG. 4 is a partly enlarged view of FIG. 3, including a sectional view of an automatic play adjusting mechanism according to the first exemplary embodiment.

FIG. 5A is a front view of a pull rod according to the first exemplary embodiment.

FIG. 5B is a sectional view taken along line VB-VB in FIG. 5A.

FIG. 6A is a front view of an outer pipe according to the first exemplary embodiment.

FIG. 6B is a sectional view taken along line VIB-VIB in FIG. 5A.

FIG. 7A is a front view of an inner pipe according to the first exemplary embodiment.

FIG. 7B is a sectional view taken along line VIIB-VIIB in FIG. 7A.

FIG. 8A is a front view of an auxiliary spring according to the first exemplary embodiment.

FIG. 8B is a sectional view taken along line VIIIB-VIIIB in FIG. 8A.

FIG. 9A is a front view of a slide plate according to the first exemplary embodiment.

FIG. 9B is a sectional view taken along line IXB-IXB in FIG. 9A.

FIG. 10A is a front view of an auxiliary spring according to the first embodiment.

FIG. 10B is a sectional view taken along line XB-XB in FIG. 10A.

FIG. 11A is a front view of a lock plate according to the first exemplary embodiment.

FIG. 11B is a sectional view taken along line XIB-XIB in FIG. 11A.

FIGS. 12A to 12C are views showing an operation of the automatic play adjusting mechanism according to the first exemplary embodiment; more specifically, FIG. 12A is a sectional view of a clutch connected state, FIG. 12B is a sectional view in a touch point, and FIG. 12C is a sectional view of a clutch disconnected state.

FIG. 13 is a sectional view of a clutch and a clutch release mechanism according to a second exemplary embodiment of the invention.

FIG. 14 is a sectional view of the clutch according to the second exemplary embodiment.

FIG. 15A is a front view of a collar according to the second exemplary embodiment.

FIG. 15B is a sectional view taken along line XVB-XVB in FIG. 15A.

FIG. 16A is a front view of a slide plate according to the second embodiment.

FIG. 16B is a sectional view taken along line XVIB-XVIB in FIG. 16A.

FIG. 17A is a front view of an annular plate according to the second exemplary embodiment.

FIG. 17B is a sectional view taken along line XVIIB-XVIIB in FIG. 17A.

FIG. 18A is a front view of an auxiliary spring according to the second exemplary embodiment.

FIG. 18B is a sectional view taken along line XVIIIB-XVIIIB in FIG. 18A.

FIG. 19A is a front view of an auxiliary spring according to the second exemplary embodiment.

FIG. 19B is a sectional view taken along line XIXB-XIXB in FIG. 19A.

FIG. 20A is a front view of an inner pipe according to the second exemplary embodiment.

FIG. 20B is a sectional view taken along line XXB-XXB in FIG. 20A.

FIG. 21A is a front view of an outer pipe according to the second exemplary embodiment.

FIG. 21B is a sectional view taken along line XXIB-XXIB in FIG. 21A.

FIG. 22A is a front view of a lock plate according to the second exemplary embodiment.

FIG. 22B is a sectional view taken along line XXIIB-XXIIB in FIG. 22A.

FIG. 23A is a front view of a slide plate according to the second exemplary embodiment.

FIG. 23B is a sectional view taken along line XXIIIB-XXIIIB in FIG. 23A.

FIG. 24A is a front view of a push rod according to the second exemplary embodiment.

FIG. 24B is a sectional view taken along line XXIVB-XXIVB in FIG. 24A.

FIG. 24C is a sectional view taken along line XXIVC-XXIVC in FIG. 24A.

FIG. 25 is a sectional view of a clutch, a clutch release mechanism, and a ball cam according to a third exemplary embodiment of the invention.

FIG. 26 is a sectional view of the clutch and the ball cam according to the third exemplary embodiment.

FIG. 27 is a partly enlarged view of FIG. 26, including a sectional view of an automatic play adjusting mechanism according to the third exemplary embodiment.

FIG. 28 is a sectional view of the ball cam according to the third exemplary embodiment in a clutch connected state.

FIG. 29 is a sectional view of the ball cam according to the third exemplary embodiment.

FIG. 30A is a front view of a slide shaft according to the third exemplary embodiment.

FIG. 30B is a sectional view taken along line XXXB-XXXB in FIG. 30A.

FIG. 30C is a sectional view taken along line XXXC-XXXC in FIG. 30A.

FIG. 31A is a front view of a collar according to the third exemplary embodiment.

FIG. 31B is a sectional view taken along line XXXIB-XXXIB in FIG. 31A.

### DETAILED DESCRIPTION OF THE INVENTION

The invention will now be described in more detail by way of example with reference to the embodiments shown in the accompanying Figures. It should be kept in mind that the following described embodiments are only presented by way of example and should not be construed as limiting the inventive concept to any particular physical configuration. It should further be understood that “exemplary” as used herein means “serving as an example, instance or illustration.” Any aspect referred to herein as “exemplary” is not necessarily to be construed as preferred over other aspects.

Further, if used and unless otherwise stated, the terms “upper,” “lower,” “front,” “back,” “over,” “under,” and similar such terms are not to be construed as limiting the invention to a particular orientation. Instead, these terms are used only on a relative basis.

Moreover, any term of degree used herein, such as “substantially,” “essentially,” “nearly” and “approximately” means a reasonable amount of deviation of the modified word is contemplated such that the end result is not significantly changed. For example, such terms can be construed as allowing a deviation of at least 5% of the modified word if this deviation would not negate the meaning of the word the term of degree modifies.

### First Exemplary Embodiment

In the following, a motorcycle 1 including a friction clutch according to a first exemplary embodiment of the invention will be described in detail in conjunction with the accompanying drawings. Note that the motorcycle 1 and the clutch 44 in the following description are simply illustrative examples of embodiments of the invention. The embodiments are not limited to implementation in a motorcycle, and may be implemented in any kind of vehicle. For example, embodiments of the inventions can be realized in a “saddle-type” vehicle, such as an ATV (All Terrain Vehicle) or a snowmobile, in addition to a vehicle such as a motorcycle, a moped (e.g., a motorized bicycle), or a scooter. While the specification mainly refers to implementations involving a motorcycle (thus, for example, a vehicle whose body may be inclined while it turns), the implementations are not limited to a two-wheel vehicle. For example, the number of wheels may be three or more. For example, the vehicle can be a four-wheel vehicle.

The following description includes references to directions, such as “front,” “frontward,” “ahead,” “back,” “rear,” “rearward,” “behind,” “right,” “left,” “above,” “below,” “up,” “upward,” “down,” “downward,” “forward,” “backward,” “widthwise,” “lengthwise,” “horizontal” and “vertical.” As used herein, these terms reflect the perspective of a person facing in the direction indicated by the arrow labeled “FWD” in the drawings, such as a rider seated on or straddling the motorcycle 1 and facing toward the front wheel 14. Thus, the arrow labeled “FWD” indicates a back-to-front direction relative to the motorcycle 1, or an advancing direction of the motorcycle 1. A direction specified as “left” or “right” in the description refers to left or right with respect to the FWD direction or a direction opposite (e.g. 180 degrees from) to the FWD direction. “Widthwise” corresponds to a direction substantially transverse to the FWD direction or to a direction opposite to the FWD direction, e.g., a left-to-right or right-to-left direction. “Lengthwise” (with respect to the motorcycle 1) corresponds substantially to the FWD direction or to a direction opposite to the FWD direction. “Vertical” refers to a direction substantially transverse to both the widthwise and lengthwise directions, and corresponds substantially to “upward” and/or “downward.” “Horizontal” refers to a direction substantially transverse to the vertical direction, and corresponds substantially to the FWD direction or to a direction opposite to the FWD direction.

Structure of Motorcycle

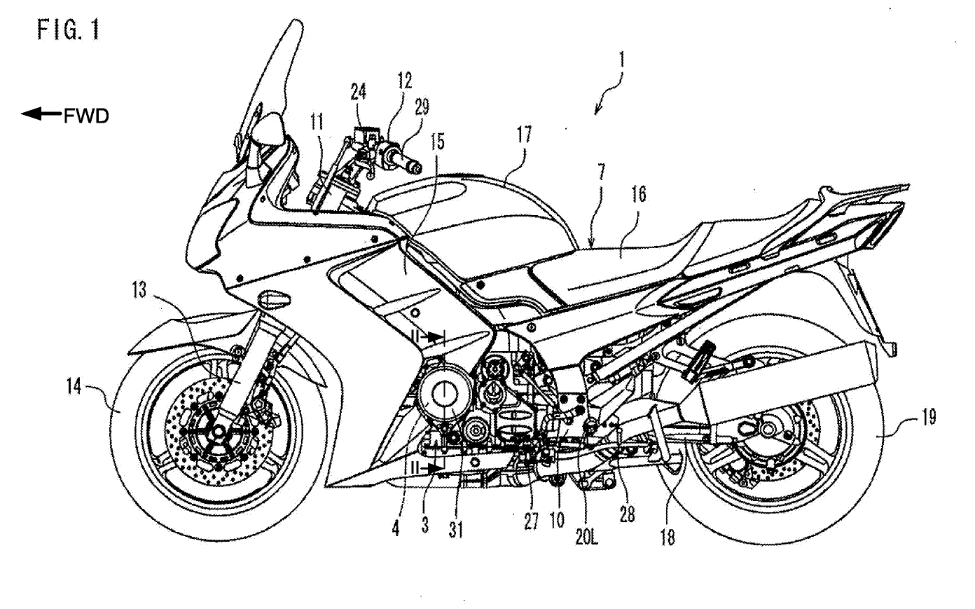

FIG. 1 is a left side view of the motorcycle 1. As shown in FIG. 1, the motorcycle 1 can include a vehicle main body 7, a front wheel 14 provided on the front side of the vehicle main body 7, and a rear wheel 19 provided on the rear side of the vehicle main body 7.

The vehicle main body 7 can include a body frame 10 having a head pipe 11. A handle 12 can be attached at the upper end of the head pipe 11. The front wheel 14 can be rotatably provided through a front fork 13 under the head pipe 11.

The body frame 10 can have a power unit 3 suspended therefrom. The body frame 10 can be provided with a body cover 15. A seat 16 can be provided on substantially a rear side with respect to a center of the vehicle main body 7. A fuel tank 17 can be provided in front of the seat 16.

A rear arm 18 can be swingably supported at the body frame 10. The rear wheel 19 can be rotatably attached at the rear end of the rear arm 18. The rear arm 19 can be coupled to an engine 4 through a power transmission mechanism that is not shown. In this way, the power of the engine 4 can be transmitted to the rear wheel 19, causing the rear wheel 19 to rotate.

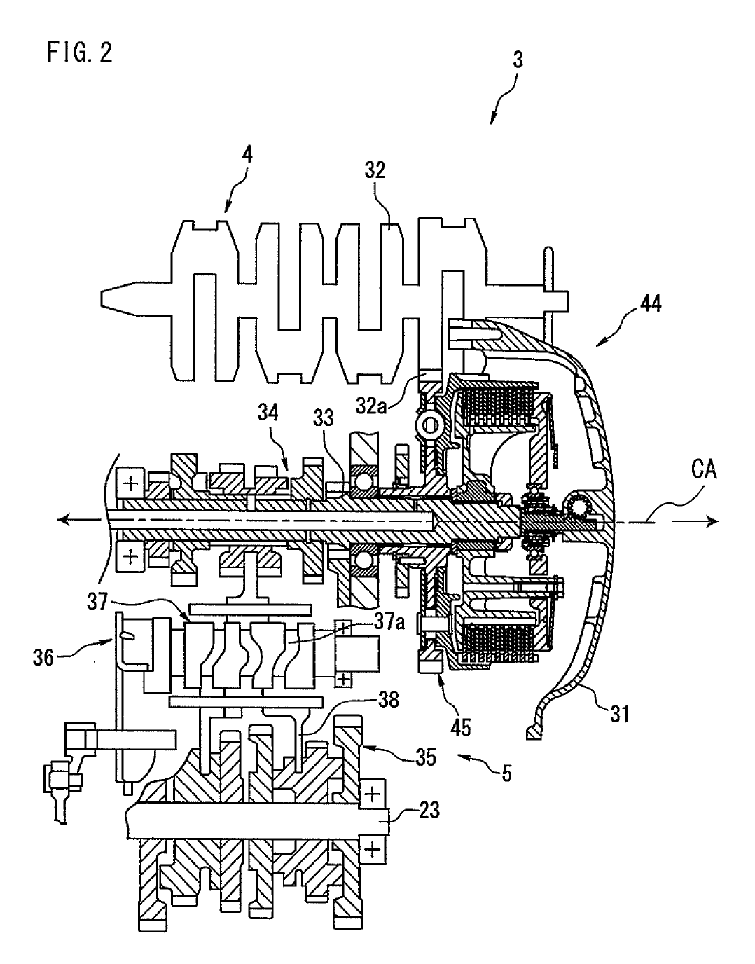

An accelerator grip (not shown) can be provided on the right side of the handle 12. A left side grip 29 can be provided on the left side of the handle 12. A clutch lever 24 can be provided on the left side of the handle 12. The clutch lever 24 can be provided in front of the left side grip 29. A clutch 44 (see FIG. 2) can be disconnected based on the operation of the clutch lever 24. When operated by a rider, the clutch lever 24 can be rotated in a prescribed direction.

Footrests 20L can be provided on the left and right sides of the vehicle main body 7 in substantially or approximately a center position with respect to a front-to-back direction. A shift pedal 27 can be provided on the left side of the vehicle main body 7 in front of the left foot rest 20L. A transmission device 5 (see FIG. 2) can have its transmission gear ratio changed based on the operation of the shift pedal 27. A side stand 28 can be provided on the left side of the vehicle main body 7, and under the shift pedal 27 and the foot rest 20L.

Structure of Power Unit

Now, referring to FIG. 2, main elements of a power unit 3 will be described. As shown in FIG. 2, the power unit 3 can include the engine 4, the transmission device 5, and the clutch 44. The engine 4 can be, for example, a water-cooled-type 4-cycle engine, but the engine 4 is not limited in this respect. Alternatively, for example, the engine 4 could be an air-cooled engine.

The engine 4 can include a crankshaft 32 that extends in a vehicle widthwise direction. The power unit 3 can have a crankcase 31 at an outer side.

As shown in FIG. 2, the crankshaft 32 can be connected to the transmission device 5 through the clutch 44. The transmission device 5 can include a main shaft 33, a drive shaft 23, and a gear selecting mechanism 36. The main shaft 33 can be connected to the crankshaft 32 through the clutch 44. The main shaft 33 and the drive shaft 23 can be arranged so as to be parallel to the crankshaft 32. The main shaft 33 can extend in a clutch axial direction CA.

Multiple transmission gears 34 can be mounted at the main shaft 33. Multiple transmission gears 35 corresponding to the multiple transmission gears 34 can be provided at the drive shaft 23. The multiple transmission gears 34 and the multiple transmission gears 35 can be engaged with one another between a pair of selected gears. Transmission gears 34 other than the selected transmission gear 34 or the transmission gears 35 other than the selected transmission gear 35 can rotate around the main shaft 33 or the drive shaft 23. More specifically, the unselected gears 34 or the unselected gears 35 can be made to idle around the main shaft 33 or the drive shaft 23. Still more specifically, rotation transmission between the main shaft 33 and the drive shaft 23 may be carried out through the selected transmission gears 34 and 35 that are engaged with each other.

The transmission gears 34 and 35 can be selected by the gear selection mechanism 36. More specifically, the transmission gears 34 and 35 can be selected by a shift cam 37 in the gear selecting mechanism 36. A plurality of cam grooves 37a can be provided at an outer circumferential surface of the shift cam 37. A shift fork 38 can be provided in each of the cam grooves 37a. The shift forks 38 can be engaged with prescribed (e.g., selected) transmission gears 34 and 35 of the main shaft 33 and the drive shaft 23. The rotation of the shift cam 37 can cause the shift forks 38 to be guided into the cam grooves 37 and moved in the axial direction of the main shaft 33. In this way, gears to be engaged with each other can be selected among the transmission gears 34 and 35. More specifically, among the transmission gears 34 and 35, a pair of gears in a position corresponding to the rotation angle of the shift cam 37 can be fixed by spline to the main shaft 33 and the drive shaft 23. This can allow a transmission gear position of the transmission device 5 to be determined, and rotation to be transmitted between the main shaft 33 and the drive shaft 23 at a prescribed transmission gear ratio through the transmission gears 34 and 35. The gear selecting mechanism 36 can be operated by the shift pedal 27 shown in FIG. 1. The operation of the shift pedal 27 can rotate the shift cam 37 in a prescribed direction.

As described in the foregoing, a prescribed pair of transmission gears 34 and 35 can be fixed to the main shaft 33 and the drive shaft 23, the clutch 44 can be connected, and the engine 4 can be driven, so that the power of the engine 4 can be transmitted to the main shaft 33 through the clutch 44. Rotation can be transmitted between the main shaft 33 and the drive shaft 23 through the prescribed pair of transmission gears 34 and 35 at a prescribed transmission gear ratio, so that the drive shaft 23 is driven. When the drive shaft 23 is driven, a transmission mechanism (not shown) such as a chain that connects the drive shaft 23 and the rear wheel 19 can transmit the driving power, so that the rear wheel 19 is rotated. The power transmission mechanism that connects the engine 4 and the rear wheel 19 can include at least the clutch 44, the transmission device 5, and the transmission mechanism (not shown) such as a chain.

Structure of Clutch

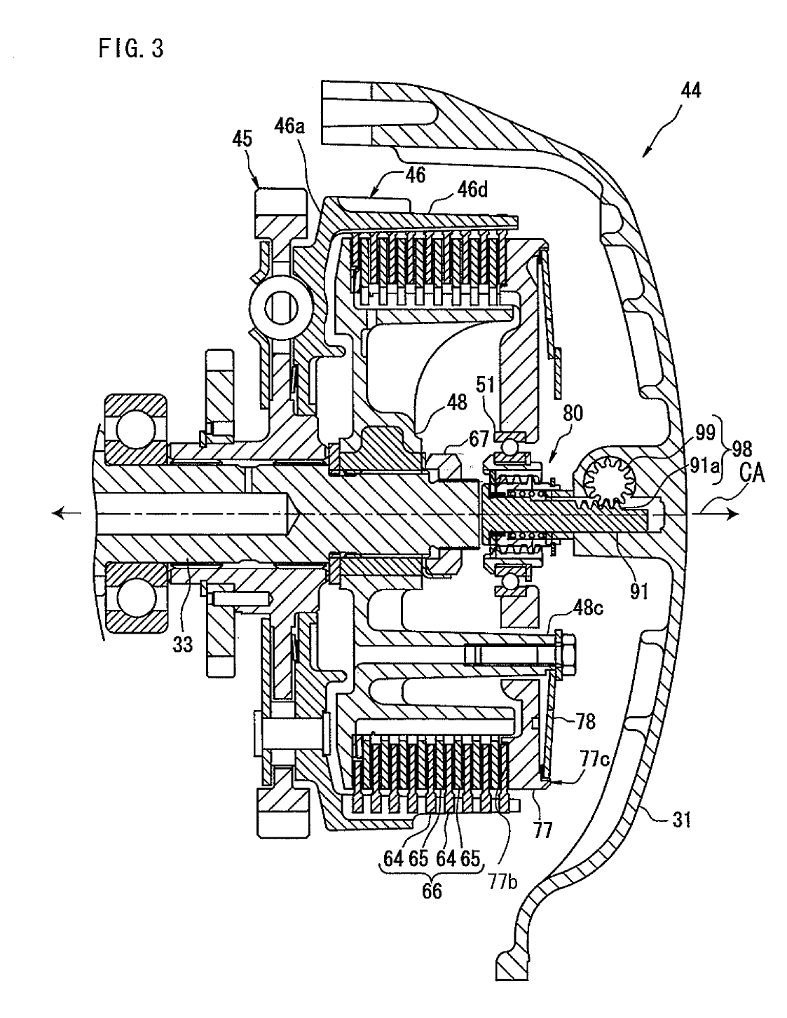

As shown in FIG. 2 or FIG. 3, the clutch 44 according to the first exemplary embodiment can be, for example, a wet-type multi-plate friction clutch. However, the clutch 44 is not limited in this respect. For example, the clutch 44 can be a dry-type friction clutch or a single-plate friction clutch. The clutch 44 can include a clutch housing 46, a clutch boss 48, and a pressure plate 77.

As shown in FIG. 2 or FIG. 3, the clutch 44 can be provided on the right side of the main shaft 33. However, the orientation or position of the clutch 44 is not limited in this respect, and the clutch 44 may be implemented in other positions relative to the main shaft 33 or other structures of the motorcycle 1.

Clutch Housing 46

As shown in FIG. 3, the clutch 44 can include the clutch housing 46. The main shaft 33 can penetrate or extend through the clutch housing 46. The clutch housing 46 can have a bottom portion 46a that is approximately cylinder-shaped. The bottom portion 46a can have the main shaft 33 inserted therethrough. The clutch housing 46 can be provided with a plurality of arms 46d. The arms 46d can each extend to the right from the bottom portion 46a.

Gear 45

The clutch housing 46 can be provided with a gear 45. The gear 45 can be engaged with a gear 32a (see FIG. 2) of the crankshaft 32. The gear 45 can also be fixed to the bottom portion 46a of the clutch housing 46 so that it cannot rotate relative to the bottom portion. Therefore, as the crankshaft 32 rotates, the gear 45 and the clutch housing 46 can rotate together. In this way, torque from the crankshaft 32 can be transmitted to the clutch housing 46 through the gears 32a and 45.

The gear 45 and the main shaft 33 can rotate relative to each other. The gear 45 can be rotatable around the main shaft 33. The rotation of the gear 45 may not be directly transmitted to the main shaft 33.

Clutch Boss 48

The clutch boss 48 can be fixed by a nut 67 at the main shaft 33 so that it cannot rotate. The clutch boss 48 can rotate together with the main shaft 33.

Plate Group 66

A plurality of friction plates 64 can be provided inside the clutch housing 46 in a plate group 66. The friction plates 64 can each be fixed to the clutch housing 46 and supported rotatably around the main shaft 33. In this way, the plurality of friction plates 64 can rotate together with the clutch housing 46. The friction plates 64 can each be displaceable in the clutch axial direction CA. Therefore, the distance between adjacent friction plates 64 can be variable.

The plurality of friction plates 64 can be arranged along the clutch axial direction CA. A clutch plate 65 can be provided between adjacent friction plates 64, so that friction plates 64 and clutch plates 65 alternate with one another along the clutch axial direction CA. The clutch plates 65 can be opposed to adjacent friction plates 64. The clutch plates 65 can each be fixed to the clutch boss 48 and supported by the main shaft 33. In this way, a plurality of clutch plates 65 can rotate together with the clutch boss 48. The clutch plates 65 can each be displaceable in the clutch axial direction CA. Therefore, the distance between adjacent clutch plates 65 can be variable.

According to the first exemplary embodiment under discussion, the plurality of friction plates 64 and the plurality of clutch plates 65 can form the plate group 66.

Pressure Plate 77

The pressure plate 77 can be provided on the right side of the main shaft 33. The pressure plate 77 can have an approximately circular disk shape. The pressure plate 77 can have a pressurizing portion 77b arranged to project to the side of the plate group 66 on an inner side of an outer circumference of the plate group 66. The pressurizing portion 77b can be opposed to a friction plate 64 in a rightmost position in the plate group 66. Alternatively, a clutch plate 65 may be provided on the rightmost side of the plate group 66. When the pressure plate 77 moves to the left, the pressurizing portion 77b can push the plate group 66 to the left. As a result, the friction plates 64 and the clutch plates 65 in the plate group 66 can be rubbed against one another.

A retainer 77c can be formed on an outside side of an outer extension of the pressure plate 77. A plurality of cylindrical guides 48c that extend in the clutch axial direction CA can be provided at an inner side of the tubular clutch boss 48. The guides 48c can, for example, be formed integrally with the clutch boss 48.

One end of a clutch spring 78 formed, for example, as a coned disk spring, can be attached to the guide 48c. The other end of the clutch spring 78 can be attached to the retainer 77c of the pressure plate 77. More specifically, the clutch spring 78 can have an approximately annular shape. In this way, the clutch spring 78 can push the pressure plate 77 to the left, with reference to FIG. 3. In other words, the clutch spring 78 can push the pressure plate 77 to connect the clutch 44.

The pressure plate 77 can be pushed by the clutch spring 78, and move to the left in the clutch axial direction CA when the clutch 44 is connected. Upon receiving the pushing force of the clutch spring 78, the pressure plate 77 can cause the plates of the plate group 66 to be rubbed against one another. In this way, friction force can be generated between the friction plates 64 and the clutch plates 65, so that the driving force of the engine 4 is transmitted from the clutch housing 46 to the clutch boss 48. The state of the clutch 44 at the time can be considered to be a connected state. More specifically, when the clutch 44 is connected, the clutch boss 48 can rotate together with the clutch housing 46.

On the other hand, when the clutch 44 is in what can be considered to be a disconnected state, a pull rod 91 can move to the right and the pressure plate 77 can also move to the right, against the pushing force of the clutch spring 78. As a result, the state in which the friction plates 64 and the clutch plates 65 are rubbed against each other is discontinued, so that the friction plates 64 and the clutch plates 65 are separated from each other. In this way, the driving force of the engine 4 may no longer be transmitted from the clutch housing 46 to the clutch boss 48. The state of the clutch 44 as described in the foregoing may be considered a disconnected state.

When the clutch lever 24 shown in FIG. 1 is operated by a rider, the pull rod 91 can move to the right. A rack 91a can be formed at the right part of the pull rod 91. The rack 91a can be engaged with a pinion 99. In this way, when the clutch lever 24 is operated, the pinion 99 can rotate and the pull rod 91 can move to the right.

When the clutch 44 is switched from a disconnected state to a connected state, the pressure plate 77 can move to the left by the pushing force of the clutch spring 78. At this time, the pull rod 91 can move to the left based on the movement of the pressure plate 77. The pinion 99 and the rack 91a can form a clutch release mechanism 98.

Automatic Play Adjusting Mechanism

The clutch 44 can include an automatic play adjusting mechanism 80. The automatic play adjusting mechanism 80 can reduce a shift, caused by thermal expansion or wear of the plate group 66, of a “touch point” of the clutch 44, and automatically adjust a play amount. The touch point is a prescribed rotation position for the clutch lever 24 when the friction plates 64 and the clutch plates 65 start to be parted or separated from one another. In other words, it is the disconnection start position when the clutch 44 is disconnected.

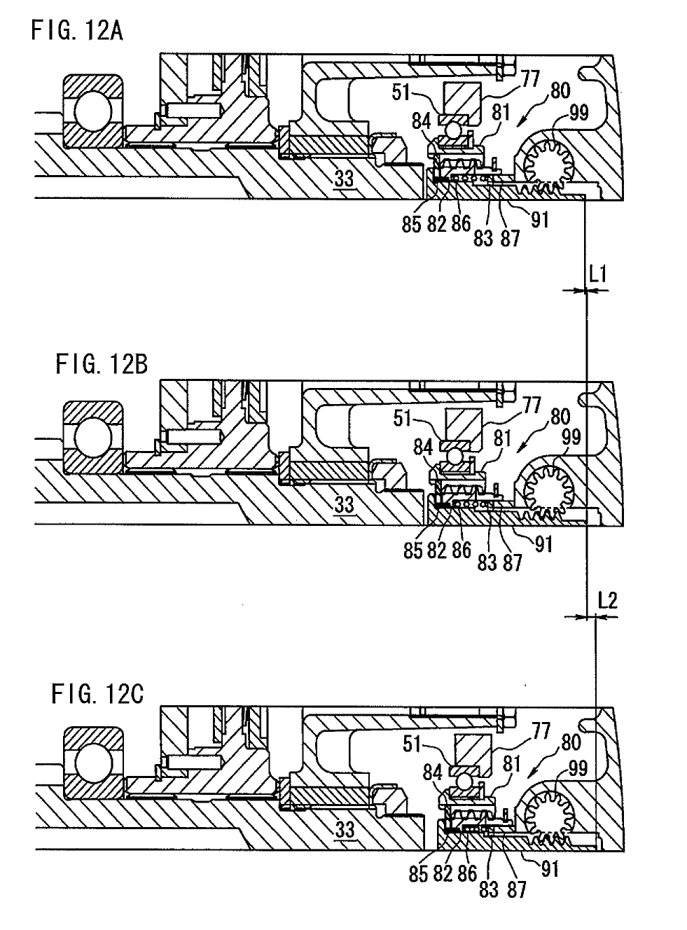

The automatic play adjusting mechanism 80 can be provided between the pressure plate 77 and the pull rod 91. The automatic play adjusting mechanism 80 can allow the pressure plate 77 to move relative to the pull rod 91 in the clutch axial direction CA in a clutch connected state. Moreover, the automatic play adjusting mechanism 80 can restrict the movement of the pressure plate 77 relative to the pull rod 91 in the clutch axial direction CA when the pull rod 91 moves more than a prescribed play amount L1 (see FIGS. 12A and 12B) to the right in the clutch axial direction CA from the clutch connected state, in other words, in a disconnected state for the clutch 44.

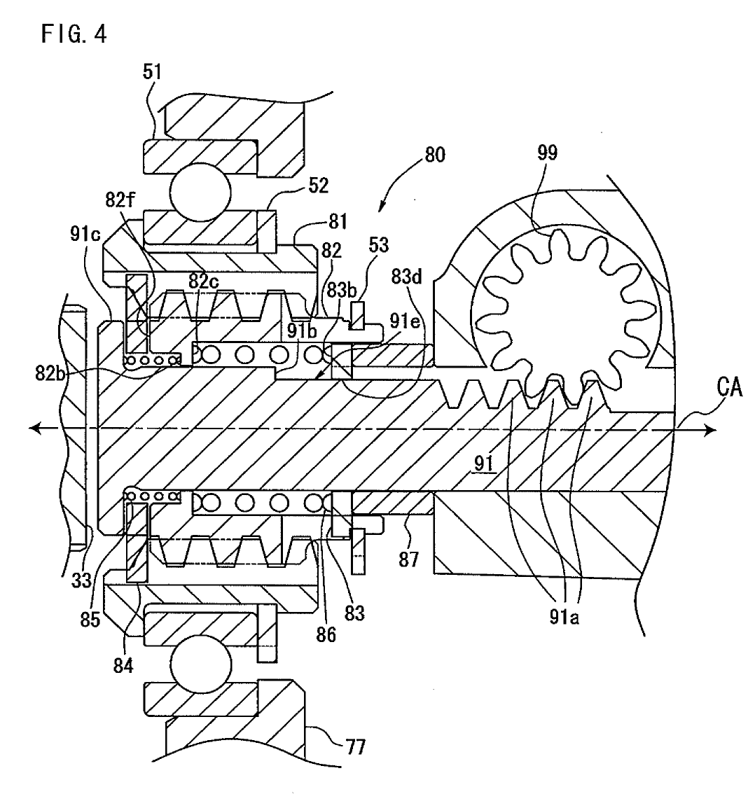

As shown in FIG. 4, the automatic play adjusting mechanism 80 can include an outer pipe 81, an inner pipe 82, an auxiliary spring 85, and a lock plate 84. The outer pipe 81 can support the pressure plate 77 so that it moves in the clutch axial direction CA together with the pressure plate 77. The inner pipe 82 can be attached to the pull rod 91 and support the outer pipe 81 to allow the relative movement of the outer pipe 81 in the clutch axial direction CA. The inner pipe 82 can move relative to the pull rod 91 in the clutch axial direction CA.

As shown in FIGS. 4, 6A and 6B, the outer pipe 81 can have an approximately cylindrical shape. The outer pipe 81 can have flanges 81a and 81b. The flange 81a can be formed on an outer side of the left end of the outer pipe 81, and the flange 81b can be formed on an outer side of the right end of the outer pipe 81. A ring shaped bearing 51 can be provided between the flange 81a and the flange 81b. A circlip 52 can be provided between the bearing 51 and the flange 81b, and the bearing 51 can be attached to the outer pipe 81. The pressure plate 77 can be provided at an outer circumference of the bearing 51. In this way, the outer pipe 81 can support the pressure plate 77 through the bearing 51. As a result, the bearing 51 and the outer pipe 81 can move together in the clutch axial direction CA. The pressure plate 77 and the outer pipe 81 can rotate around the main shaft 33.

A circlip 53 can be attached at an outer circumference of the inner pipe 82. The circlip 53 can restrict the rightward movement of the slide plate 83 relative to the inner pipe 82.

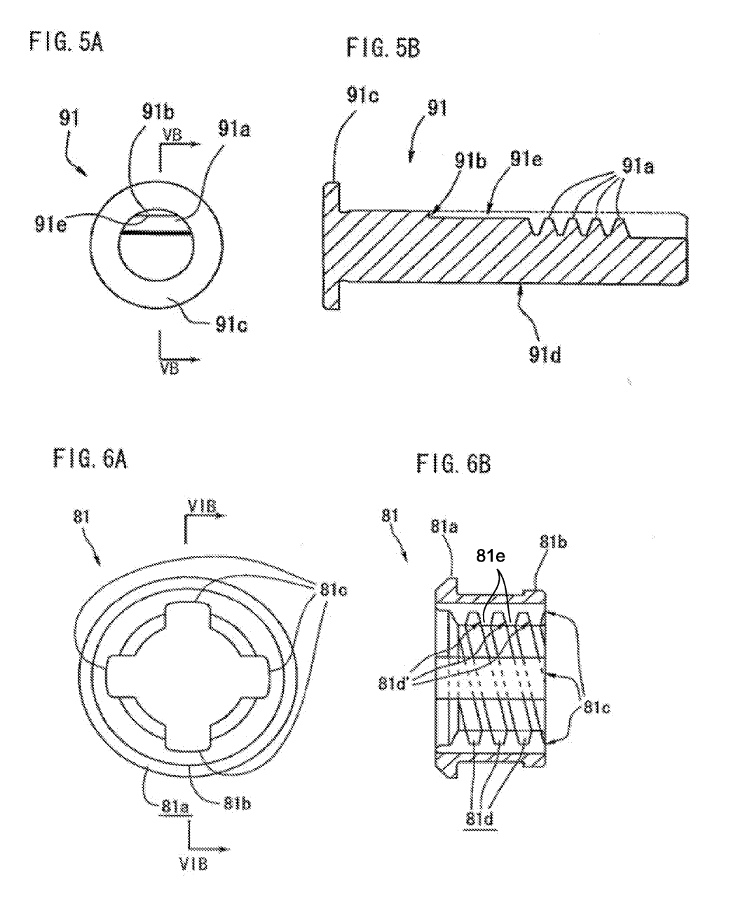

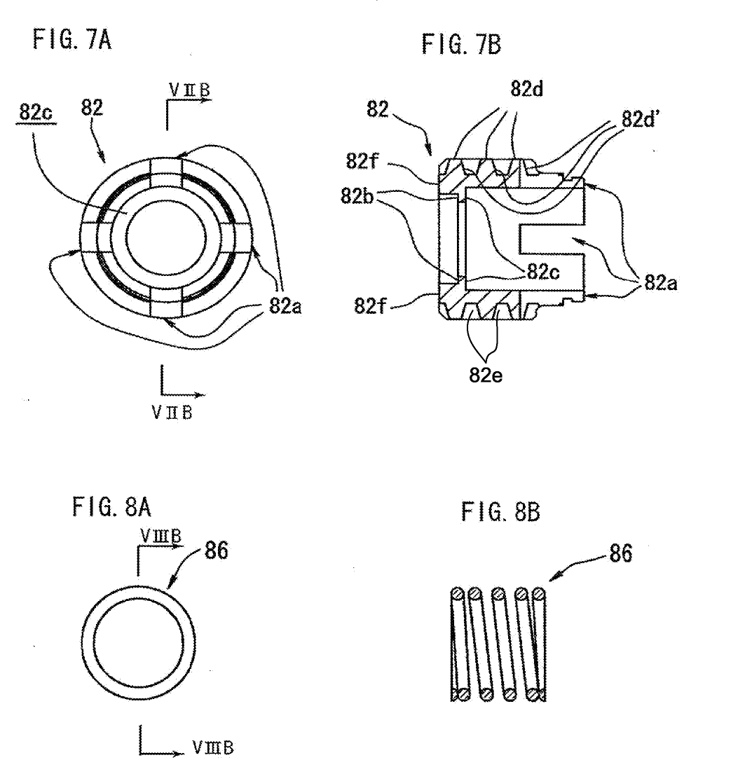

As shown in FIGS. 7A and 7B, the inner pipe 82 can have an approximately cylindrical shape. Spring retainers 82b and 82c that extend radially inward can be provided at an inner circumference of the inner pipe 82. As shown in FIGS. 5A and 5B, the pull rod 91 can have a shaft portion 91d and a pressurizing portion 91c. The shaft portion 91d can extend approximately parallel to the axial direction of the main shaft 33 (see FIG. 3). The pressurizing portion 91c can extend radially outward at the left end of the shaft portion 91d. The shaft portion 91d can penetrate or extend through the lock plate 84, the auxiliary spring 85, the auxiliary spring 86, the slide plate 83, a collar 87, and the inner pipe 82 in the clutch axial direction CA (see FIG. 4).

As shown in FIG. 4, the auxiliary spring 85 can be provided between the pressurizing portion 91c of the pull rod 91 and the spring retainer 82b of the inner pipe 82 in the clutch axial direction CA. Stated differently, the pressurizing portion 91c of the pull rod 91 can be a spring retainer arranged to receive the left end of the auxiliary spring 85, and the spring retainer 82b of the inner pipe 82 can receive the right end of the auxiliary spring 85. In this way, the auxiliary spring 85 can push the pull rod 91 to the left in the clutch axial direction CA relative the inner pipe 82. Stated differently, the auxiliary spring 85 can push the inner pipe 82 to the right in the clutch axial direction CA relative to the pull rod 91. As shown in FIGS. 10A and 10B, the auxiliary spring 85 can be, for example, a coil spring.

As shown in FIGS. 6A and 6B, the outer pipe 81 can have spiral screw grooves 81d and screw threads 81e at an inner circumferential surface. As shown in FIGS. 7A and 7B, the inner pipe 82 can have, at an outer circumferential surface, spiral screw threads 82d and screw grooves 82e to be engaged with the screw grooves 81d and the screw threads 81e of the outer pipe 81. The number of spiral turns of the spiral screw grooves and screw threads of the outer pipe 81 and the inner pipe 82 may be one or more.

As shown in FIG. 4, the lock plate 84 can be provided between the pressurizing portion 91c of the pull rod 91 and the left end of the inner pipe 82. When the pull rod 91 moves more than a prescribed play amount L1 (see FIGS. 12A and 12B) in the clutch axial direction CA against the pushing force of the auxiliary spring 85, in other words, in a clutch disconnected state for the clutch 44, the lock plate 84 can restrict the relative movement of the outer pipe 81 and the inner pipe 82 in the clutch axial direction CA, so that the outer pipe 81 and the inner pipe 82 move together with the pull rod 91 in the clutch axial direction CA.

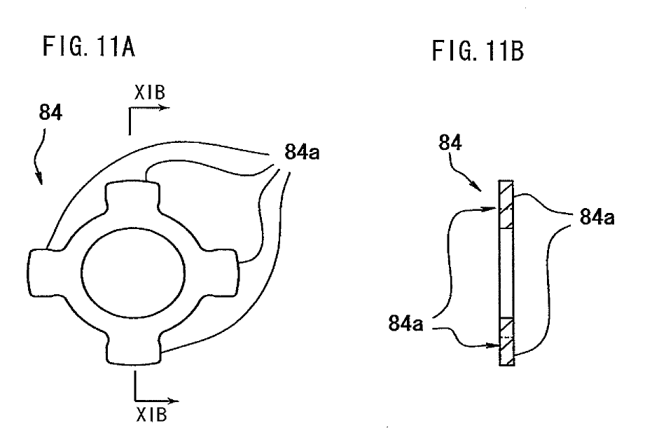

As shown in FIGS. 11A and 11B, the lock plate 84 may be a plate member having an approximately annular shape. As shown in FIG. 11A, a plurality of claws 84a can be provided at an outer side of the lock plate 84. The claws 84a can extend outward in a radial direction. Moreover, as shown in FIG. 6A, the outer pipe 81 can have grooves 81c. The grooves 81c can be formed to extend from the left end to the right end when viewed from a side. The claws 84a of the lock plate 84 can be fitted into the grooves 81c. In this way, the lock plate 84 can be arranged to move relative to the outer pipe 81 in the clutch axial direction CA. The lock plate 84 can be arranged so that it does not rotate relative to the outer pipe 81 around the main shaft 33.

Further, as shown in FIG. 7B, the inner pipe 82 can have a pressurizing portion 82f abutting against the lock plate 84. The pressurizing portion 82f can be provided at the left end of the inner pipe 82. The pressurizing portion 82f can push the right side of the lock plate 84 when the pull rod 91 moves to the right in the clutch axial direction CA against the pushing force of the clutch spring 78 (see, e.g., FIGS. 12A to 12C).

As shown in FIG. 5B, the shaft portion 91d of the pull rod 91 can include a stepped portion 91b. A part of the shaft portion 91d on the right side of the stepped portion 91b in FIG. 5B can have a flat slide surface 91e. An annular portion 83b of the slide plate 83 can be abutted against the auxiliary spring 86 (see FIG. 4).

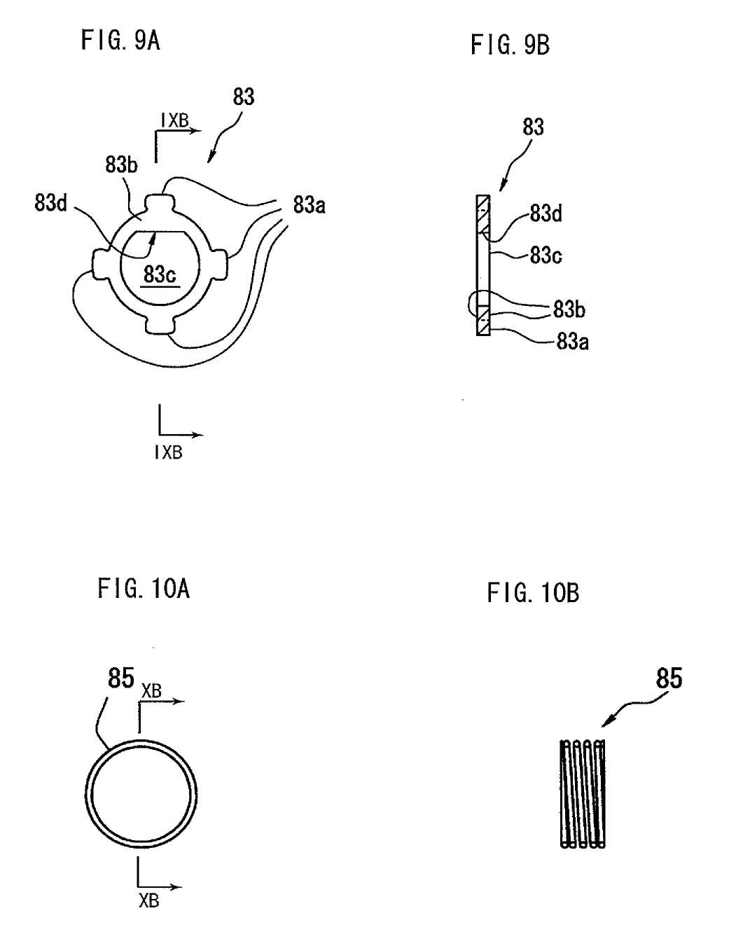

The clutch 44 can include the slide plate 83 that moves on the slide surface 91e of the pull rod 91 in the right-to-left direction. As shown in FIGS. 9A and 9B, the slide plate 83 can have an approximately annular shape. The slide plate 83 can have a hole 83c formed therein, in approximately or substantially a center region of the slide plate 83. An upper side of the hole 83c can be formed as a substantially straight or flat cut surface 83d.

As shown in FIG. 9A, a plurality of claws 83a can be formed at an outer side of the slide plate 83. The claws 83a can extend outward in a radial direction. Moreover, as shown in FIG. 7A, the inner pipe 82 can have grooves 82a. As shown in FIG. 7B, the grooves 82a can be formed to extend leftward from the right end toward a center portion of the inner pipe 82, when viewed from a side. The claws 83a of the slide plate 83 can be fitted into the grooves 82a of the inner pipe 82. In this way, the slide plate 83 can be arranged to move relative to the inner pipe 82 in the clutch axial direction CA. The slide plate 83 can be arranged so as not to rotate relative to the inner pipe 82 around the main shaft 33.

As shown in FIG. 4, the slide plate 83 can be provided on the inner side of the inner pipe 82. The cut surface 83d of the slide plate 83 can move to the right and left in the clutch axial direction CA along the slide surface 91e of the pull rod 91. Note, however, that the collar 87 is provided on the right end of the slide plate 83. A circlip 53 can be provided on an outer side of the collar 87 and the slide plate 83. When the slide plate 83 moves a prescribed distance to the right in the clutch axial direction CA relative to the inner pipe 82, the slide plate 83 can abut against a radial inner end of the circlip 53. More specifically, the movement of the slide plate 83 relative to the inner pipe 82 to the right can be restricted by the circlip 53. Note that at least the slide plate 83, the inner pipe 82, and the pull rod 91 can be arranged so that they do not rotate around the main shaft 33.

As shown in FIG. 4, an auxiliary spring 86 can be provided on the left side of the slide plate 83. The auxiliary spring 86 can be provided in series with the auxiliary spring 85 in the clutch axial direction CA. As shown in FIGS. 8A and 8B, the auxiliary spring 86 can be, for example, a coil spring.

As shown in FIG. 7B, the inner pipe 82 can have a spring retainer 82c. As shown in FIG. 4, the auxiliary spring 86 can be provided between the spring retainer 82c of the inner pipe 82 and the annular portion 83b of the slide plate 83 in the clutch axial direction CA. The annular portion 83b can be a spring retainer arranged to receive the right end of the auxiliary spring 86.

The auxiliary spring 86 can fix the inner pipe 82 in a prescribed position in a clutch connected state. The auxiliary spring 86 can push the lock plate 84 from the right to the left through the spring retainer 82b when the lock plate 84 restricts the relative movement of the outer pipe 81 and the inner pipe 82 in the clutch axial direction CA. Therefore, the lock plate 84 can be held between the pressurizing portion 91c and the spring retainer 82b.

As shown in FIG. 4, the collar 87 can be provided on the right side of the auxiliary spring 86 and the slide plate 83 in the clutch axial direction CA. The collar 87 can have an approximately cylindrical shape. The collar 87 can be partially inserted into the inner pipe 82. The collar 87 and the slide plate 83 can slide in the inner pipe 82 when the pull rod 91 moves in the clutch axial direction CA.

In the following, an exemplary operation of the automatic play adjusting mechanism 80 will be described. FIGS. 12A, 12B and 12C show the operation of the automatic play adjusting mechanism 80 in the clutch 44 (see FIG. 2). FIG. 12A shows the clutch 44 (see FIG. 2) in a clutch connected state, FIG. 12B shows the clutch 44 in the touch point, and FIG. 12C shows the clutch 44 in a disconnected state.

In the state shown in FIG. 12A, a gap can be formed between the left part of the lock plate 84 and the pressurizing portion 91c (see FIG. 4) of the pull rod 91 by the pushing force of the auxiliary spring 85. A gap can be formed between the right part of the lock plate 84 and the pressurizing portion 82f (see FIG. 4) at the left end of the inner pipe 82. More specifically, in the clutch connected state, the lock plate 84 can have a state such that it is not pressed against the pressurizing portion 91c on the left and the pressurizing portion 82f (see FIG. 4) at the left end of the inner pipe 82 on the right.

In other words, in the clutch connected state, a gap can be formed both on the right and left sides in the clutch axial direction CA between the screw grooves 81d (see FIG. 6B) of the outer pipe 81 and the screw threads 82d (see FIG. 7B) of the inner pipe 82. Therefore, the outer pipe 81 can move relative to the inner pipe 82 in the clutch axial direction CA and can rotate around the main shaft 33 relative to the inner pipe 82. In this way, if the plate group 66 thermally expands and the pressure plate 77 moves to the right in the clutch axial direction CA, the outer pipe 81 can rotate in a prescribed direction around the main shaft 33 relative to the inner pipe 82, and can move to the right in the clutch axial direction CA (FIG. 3). On the other hand, when the thermal expansion of the plate group 66 ends, the pressure plate 77 can move to the left in the clutch axial direction CA. When the plate group 66 wears, the pressure plate 77 can move to the left in the clutch axial direction CA. In this way, the outer pipe 81 can rotate in a direction the reverse of the prescribed direction around the main shaft 33, and move to the left in the clutch axial direction CA. This is because the inner pipe 82 can remain substantially stationary: e.g., the inner pipe 82 does not move from a prescribed position in the clutch axial direction CA by the pushing force of the auxiliary springs 85 and 86 when the plate group 66 is affected by heat.

On the other hand, in the clutch connected state, the pull rod 91 can receive reaction force from the pinion 99 at the rack 91a, and remain substantially stationary, e.g., not move, relative to the pressure plate 77 and the outer pipe 81. As described above, the pressure plate 77 and the outer pipe 81 can move together in the clutch axial direction CA through the bearing 51. More specifically, in a clutch connected state, when the plate group 66 thermally expands or the plate group 66 wears, the outer pipe 81 can move relative to the pull rod 91 in the clutch axial direction CA. Therefore, in the clutch connected state, the automatic play adjusting mechanism 80 can allow the pressure plate 77 to move relative to the pull rod 91 in the clutch axial direction CA.

Advantageously, when the plate group 66 is thermally affected and the outer pipe 81, for example due to vibration or the like due to the power unit 3, rotates around the main shaft 33 relative to the inner pipe 82 and moves in the clutch axial direction CA, causing friction between the screw grooves 81d of the outer pipe 81 and the screw threads 82d of the inner pipe 82., the automatic play adjusting mechanism 80 can absorb the effect of the heat on the plate group 66.

From the state shown in FIG. 12A, the pull rod 91 can move a prescribed play amount L1 to the right in the clutch axial direction CA as the pinion 99 rotates, and the state shown in FIG. 12B can be attained. In the state shown in FIG. 12B, the pressurizing portion 91c (see FIG. 4) of the pull rod 91 can abut against the left end surface 84b (see FIG. 11 B) of the lock plate 84. More specifically, the gap between the left part of the lock plate 84 and the pressurizing portion 91c of the pull rod 91 can be substantially eliminated. At this time, the gap between the right part of the lock plate 84 and the pressurizing portion 82f (see FIG. 4) at the left end of the inner pipe 82 can also be substantially eliminated. More specifically, in the touch point for the clutch 44, the lock plate 84 can be pressed against the pressurizing portion 91c on the left and the pressurizing portion 82f (FIG. 4) at the left end of the inner pipe 82 on the right.

In the touch point for the clutch 44, abutment surfaces 82d′ of the screw threads 82d (see FIG. 7B) of the inner pipe 82 in a clutch disconnected state can be abutted against abutment surfaces 81d′ of the screw grooves 81d (see FIG. 6B) of the outer pipe 81 in a clutch disconnected state. More specifically, the gap generated between the screw grooves 81d (see FIG. 6B) of the outer pipe 81 and the screw threads 82d (see FIG. 7B) of the inner pipe 82 can be substantially eliminated. This can restrict the movement of the outer pipe 81 relative to the inner pipe 82 in the clutch axial direction CA and the rotation of the outer pipe 81 relative to the inner pipe 82 around the main shaft 33. As a result, when the pull rod 91 moves more than a prescribed play amount L1 to the right in the clutch axial direction CA (e.g., after the touch point), the outer pipe 81, the inner pipe 82, the lock plate 84, and the pull rod 91 can move together to the right in the clutch axial direction CA. As described above, the pressure plate 77 and the outer pipe 81 move together in the clutch axial direction CA through the bearing 51. Therefore, when the pull rod 91 moves more than a prescribed play amount L1 to the right in the clutch axial direction CA (e.g., after the touch point), the movement of the pressure plate 77 relative to the pull rod 91 in the clutch axial direction CA can be restricted. More specifically, after the touch point, the pressure plate 77 and the pull rod 91 can move together to the right in the clutch axial direction CA. On the other hand, after the touch point, the slide plate 83 and the collar 87 can move to the left in the clutch axial direction CA relative to the outer pipe 81, the inner pipe 82, the lock plate 84, and the pull rod 91.

The prescribed play amount L1 is the amount of movement of the pull rod 91 until the lock plate 84 is pressed between the pressurizing portion 91c of the pull rod 91 and the pressurizing portion 82f of the inner pipe 82, and the abutment surfaces 82d′ of the inner pipe 82 are abutted against the abutment surfaces 81d′ of the outer pipe 81. The movement amount can be substantially unchanged if the pressure plate 77 is moved to the right in the clutch axial direction CA by the thermal expansion of the clutch 44. The movement amount can be substantially unchanged if the pressure plate 77 is moved to the left in the clutch axial direction CA by the wear of the plate group 66. The movement amount substantially changes, for example, when the automatic play adjusting mechanism 80 thermally expands. When the automatic play adjusting mechanism 80 thermally expands, for example, the gap between the grooves 81d of the outer pipe 81 and the screw threads 82d of the inner pipe 82 can be narrowed. Note however that in the automatic play adjusting mechanism 80, the friction heat between the outer pipe 81 and the inner pipe 82 is extremely small as compared to the friction heat between the friction plate 64 and the clutch plate 65. More specifically, the thermal expansion of the automatic play adjusting mechanism 80 is extremely small as compared to the thermal expansion of the plate group 66. Therefore, if the clutch 44 having the plate group 66 is thermally expanded, the disconnection start position for the clutch 44, in other words, the position of the touch point can be substantially unchanged.

The movement amount can substantially change when the gap between the grooves 81d of the outer pipe 81 and the screw threads 82d of the inner pipe 82 is increased, for example, by wear. However, in the automatic play adjusting mechanism 80, the load applied between the grooves 81d of the outer pipe 81 and the screw threads 82d of the inner pipe 82 is extremely small as compared to the load applied on the friction plate 64 and the clutch plate 65 (i.e., the plate group 66). More specifically, the grooves 81d of the outer pipe 81 and the screw threads 82d of the inner pipe 82 in the automatic play adjusting mechanism 80 wear little as compared to the plate group 66. Therefore, when the thickness of the friction plate 64 or the clutch plate 65 is reduced by wear or the like, the disconnection start position for the clutch 44, in other words, the position of the touch point can be substantially unchanged.

When the pull rod 91 moves a prescribed amount L2 to the right in the clutch axial direction CA from the state shown in FIG. 12B as the pinion 99 rotates, the state shown in FIG. 12C can be attained. The pressure plate 77 and the pull rod 91 can move together to the right in the clutch axial direction CA from the state shown in FIG. 12B to the state shown in FIG. 12C, e.g., from the touch point to the clutch disconnected state. From the touch point to the clutch disconnected state, the slide plate 83 and the collar 87 can move to the left in the clutch axial direction CA relative to the outer pipe 81, the inner pipe 82, the lock plate 84, and the pull rod 91.

As described above, the clutch 44 according to the first exemplary embodiment can include the automatic play adjusting mechanism 80. The automatic play adjusting mechanism 80 can be interposed between the pressure plate 77 and the pull rod 91, and allow movement of the pressure plate 77 relative to the pull rod 91 in the clutch axial direction CA in a clutch connected state where the pressure plate 64 and the clutch plate 65 are pressed against each other. Moreover, the automatic play adjusting mechanism 80 can restrict movement of the pressure plate 77 relative to the pull rod 91 in the clutch axial direction CA when the pull rod 91 moves more than a prescribed play amount L1 (see FIGS. 12A and 12B) to the right in the clutch axial direction CA from a clutch connected state.

When the clutch 44 according to the first exemplary embodiment is thermally expanded, the pressure plate 77 can be pushed to the right in the clutch axial direction CA by the plate group 66, and the pressure plate 77 can move to the right in the clutch axial direction CA. In a clutch connected state, however, the pressure plate 77 can move relative to the pull rod 91 in the clutch axial direction CA due to the automatic play adjusting mechanism 80. More specifically, if the thermal expansion of the clutch 44 increases the size (e.g., thickness) of the friction plate 64 and the clutch plate 65 in the clutch axial direction CA, the pressure plate 77 can move to the right in the clutch axial direction CA relative to the pull rod 91. The position of the pull rod 91 in the clutch axial direction CA can be substantially unchanged if the friction plate 64 and the clutch plate 65 increase in thickness because of the thermal expansion of the clutch 44. As a result, the automatic play adjusting mechanism 80 can absorb the shift of the touch point caused by the thermal expansion of the clutch 44. Moreover, the position where the clutch 44 is disconnected is the position reached by the pull rod 91 after moving a prescribed play amount L1 (see FIGS. 12A and 12B) to the right in the clutch axial direction CA. This position can be substantially unchanged if the pressure plate 77 moves to the right in the clutch axial direction CA due to the thermal expansion of the clutch 44. More specifically, the disconnection start position for the clutch 44 or the position of the touch point can be substantially unchanged if the clutch 44 is thermally expanded. Therefore, with the clutch 44 according to the first exemplary embodiment, the shift of the touch point caused by the thermal expansion can be reduced.

With the clutch 44 according to the first exemplary embodiment, when the thickness of the friction plate 64 or the clutch plate 65 is reduced by wear, the pressure plate 77 can be moved to the left in the clutch axial direction CA by the pushing force of the clutch spring 78. In a clutch connected state, however, the pressure plate 77 can move relative to the pull rod 91 in the clutch axial direction CA due to the automatic play adjusting mechanism 80. More specifically, when the thickness of the friction plate 64 or the clutch plate 65 is reduced by wear, the pressure plate 77 can move relative to the pull rod 91 to the left in the clutch axial direction CA. The position of the pull rod 91 in the clutch axial direction CA can be substantially unchanged when the thickness of the friction plate 64 or the clutch plate 65 is reduced. As a result, the automatic play adjusting mechanism 80 can absorb the shift of the touch point when the thickness of the friction plate 64 or the clutch plate 65 is reduced by wear. On the other hand, the position where the clutch 44 is disconnected is the position reached by the pull rod 91 after moving the prescribed play amount L1 (see FIGS. 12A and 12B) to the right in the clutch axial direction CA. This position can be substantially unchanged when the pressure plate 77 is moved to the left in the clutch axial direction CA by the wear of the plate group 66. More specifically, when the thickness of the friction plate 64 or the clutch plate 65 is reduced by wear, the disconnection start position for the clutch 44 or the position of the touch point can be substantially unchanged. Therefore, with the clutch 44 according to the first exemplary embodiment, the shift of the touch point caused by the wear of the plate group 66 can be reduced.

### Second Exemplary Embodiment

According to the first exemplary embodiment, the clutch 44 can be disconnected when the pull rod 91 is pulled to the right in the clutch axial direction CA by the clutch release mechanism 98. More specifically, the clutch 44 according to the first exemplary embodiment described above can include a so-called outer pull mechanism. However, the clutch 44 may include a so-called inner push mechanism. In the clutch 44 according to the second exemplary embodiment, a rod provided in a hollow main shaft 33 can be pushed to the right in the clutch axial direction CA, so that the clutch 44 is disconnected. In the following description, elements having the same effects as those described with reference to the first exemplary embodiment are designated by the same reference characters used for the elements in the previous description, and their detailed description is omitted for conciseness.

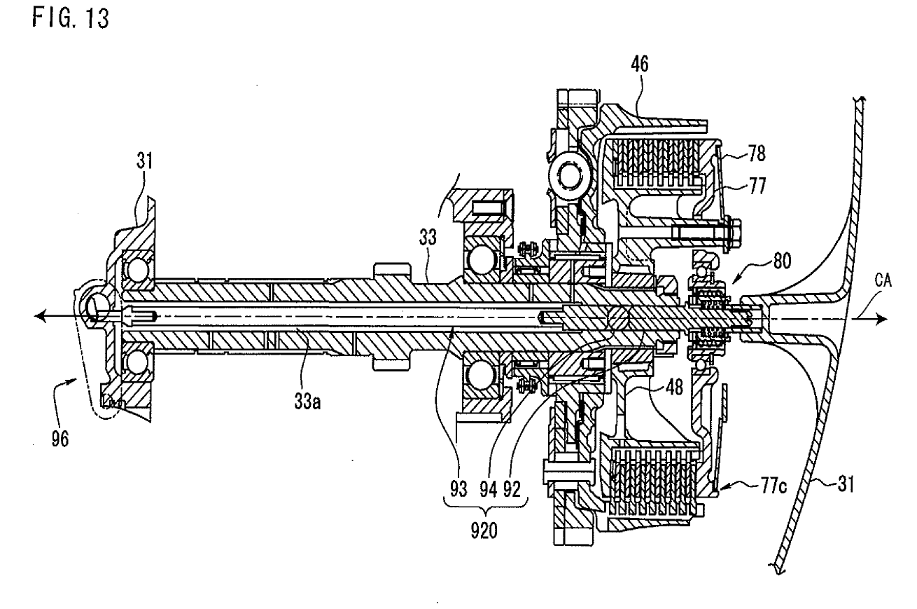

As shown in FIG. 13, the clutch 44 according to the second exemplary embodiment can include a push member 920 and a clutch release mechanism 96 arranged to push the push member 920 to the right in the clutch axial direction CA. The clutch release mechanism 96 can forcibly release the pressurized contact state of the plate group 66 in response to the operation of the clutch lever 24 by the rider of the motorcycle 1. The clutch 44 can thus be disconnected by an operation of the clutch release mechanism 96.

The push member 920 can include a short push rod 92, a long push rod 93, and a ball 94 interposed between the short push rod 92 and the long push rod 93. A through hole 33a can be formed in the main shaft 33, and the push member 920 can be provided in the through hole 33a. The right end of the short push rod 92 can project from the main shaft 33.

The clutch release mechanism 96 can operate based on the operation of the clutch lever 24 (see FIG. 1) by the rider of the motorcycle 1. By operation of the clutch lever 24, the long push rod 93, the ball 94, and the short push rod 92 can move to the right. When the long push rod 93, the ball 94, and the short push rod 92 move to the right, the pressure plate 77 can move to the right in the clutch axial direction CA, so that the clutch 44 is disconnected.

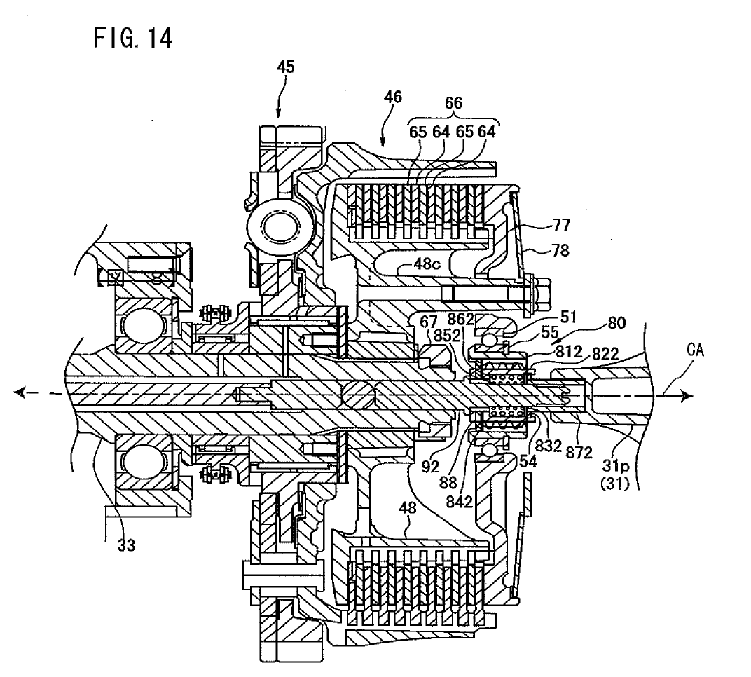

As shown in FIG. 14, the automatic play adjusting mechanism 80 according to the second exemplary embodiment can include an outer pipe 812, an inner pipe 822, an auxiliary spring 852, and a lock plate 842. The outer pipe 812 can support the pressure plate 77 so that it moves together with the pressure plate 77 in the clutch axial direction CA. The inner pipe 822 can be attached to the short push rod 92 and support the outer pipe 812 to allow the relative movement of the outer pipe 812 in the clutch axial direction CA. The inner pipe 822 can move relative to the short push rod 92 in the clutch axial direction CA.

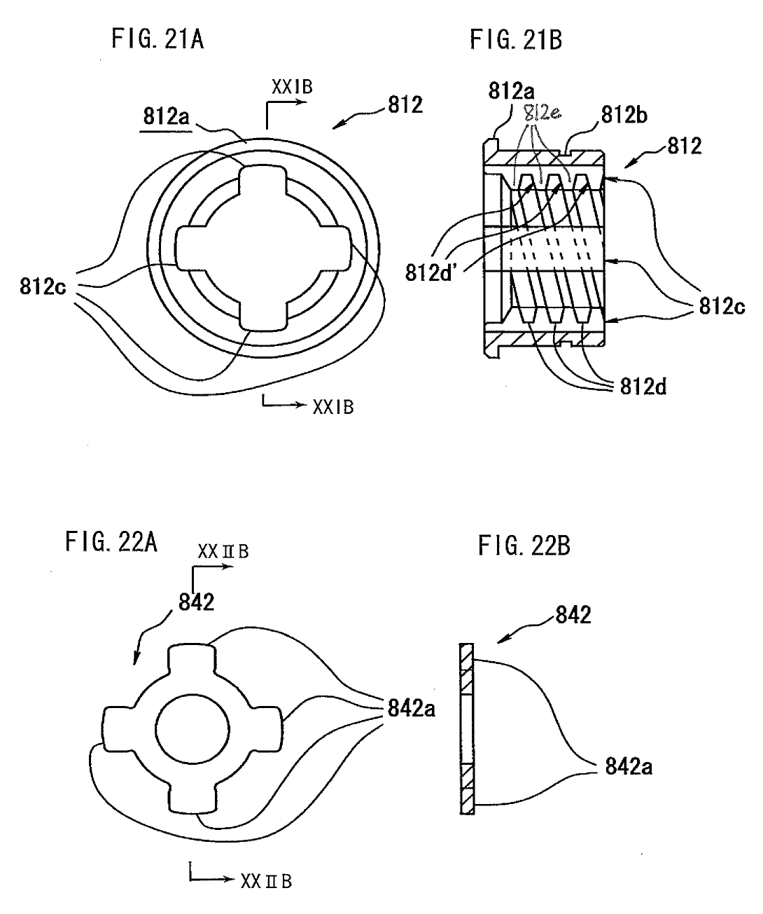

As shown in FIGS. 14, 21A and 21B, the outer pipe 812 can have an approximately cylindrical shape. The outer pipe 812 can have a flange 812a that extends radially outward at an outer circumferential portion of the outer pipe 812. The outer pipe 812 can have a clip groove 812b. The clip groove 812b can be formed on an outer circumferential surface of the outer pipe 812. The flange 812a can be formed on an outer side of the left end of the outer pipe 812, and the clip groove 812b can be formed on the right of the flange 812a. A bearing 51 can be provided between the flange 812a and the clip grooves 812b in the clutch axial direction CA. The clip groove 812b can be provided with a circlip 55 and the bearing 51 can be attached to the outer pipe 812. The pressure plate 77 can be attached at an outer side, e.g., with respect to a radial direction, of the bearing 51. In this way, the outer pipe 812 can support the pressure plate 77 through the bearing 51. As a result, the bearing 51 and the outer pipe 812 can move together in the clutch axial direction CA. The pressure plate 77 and the outer pipe 812 can rotate around the main shaft 33.

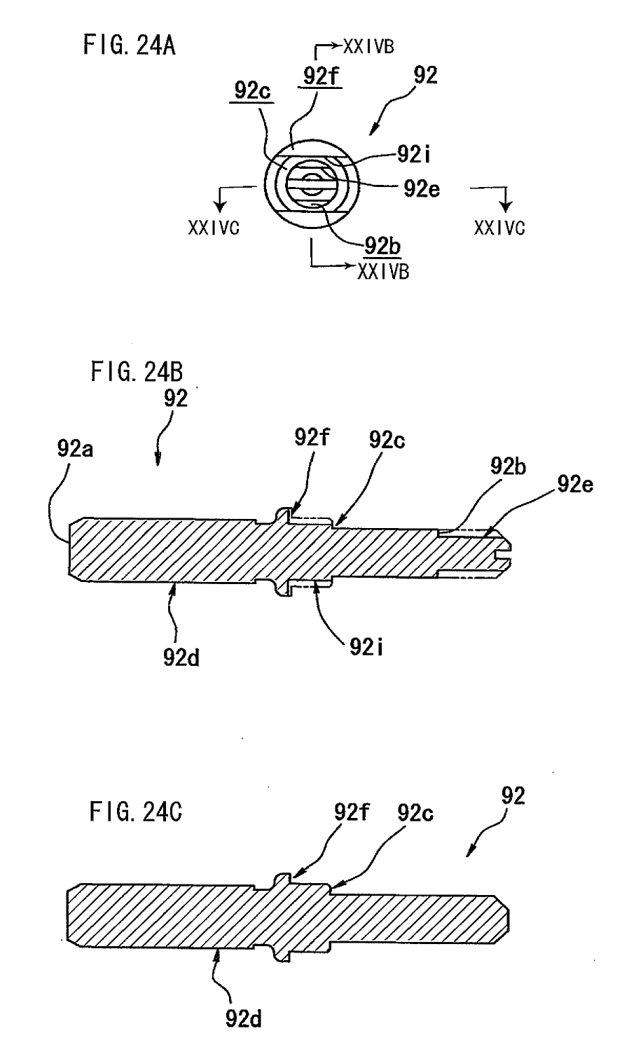

As shown in FIGS. 20A and 20B, the inner pipe 822 can have an approximately cylindrical shape. A spring retainer 822b that extends radially inward can be formed inside the inner pipe 822. Moreover, as shown in FIG. 24B, the short push rod 92 can have a shaft portion 92d, a spring retainer 92c, and a pressurizing portion 92f. The shaft portion 92d can be a part of the main shaft 33 (see FIG. 3) that extends approximately parallel to the axial direction. The spring retainer 92c can be a part of the shaft portion 92d having a comparatively large outer diameter. The pressurizing portion 92f can be formed at the shaft portion 92d and extend in a flange shape radially outward on the left of the spring retainer 92c. A slide surface 92i can be formed in a substantially flat shape between the pressurizing portion 92f and the spring retainer 92c of the shaft portion 92d. On the slide surface 92i, the lock plate 842 (see FIG. 14), a spacer 88 (see FIG. 14), and a part of the inner pipe 822 move in the clutch axial direction CA relative to the short push rod 92. The part of the shaft portion 92d on the right of the pressurizing portion 92f can penetrate or extend through the lock plate 842, an auxiliary spring 852, an auxiliary spring 862, a slide plate 832, a collar 872 and the inner pipe 822 in the clutch axial direction CA (see FIG. 14).

The left end surface 92a of the short push rod 92 can be abutted against the ball 94 (see FIG. 14). As shown in FIG. 24B, the shaft portion 92d of the short push rod 92 can include a stepped shape in its right part. The stepped part of the shaft portion 92d can act as a stopper portion 92b. The slide surface 92e can have a substantially flat shape at the part of the shaft portion 92d on the right of the stopper portion 92b.

As shown in FIG. 14, the clutch 44 can include the slide plate 832. The slide plate 832 can move between the spring retainer 92c and the stopper portion 92b of the shaft portion 92d of the short push rod 92 in the clutch axial direction CA. As shown in FIGS. 16A and 16B, the slide plate 832 can be a plate member having an approximately annular shape. The slide plate 832 can have an annular portion 832b.

Additionally, as shown in FIG. 20B, the inner pipe 822 can have a clip groove 822c on an inner circumferential surface. A circlip 54 (see FIG. 14) can be attached at the clip groove 822c. The slide plate 832 can have its rightward relative movement to the inner pipe 822 restricted by the circlip 54 (see FIG. 14).

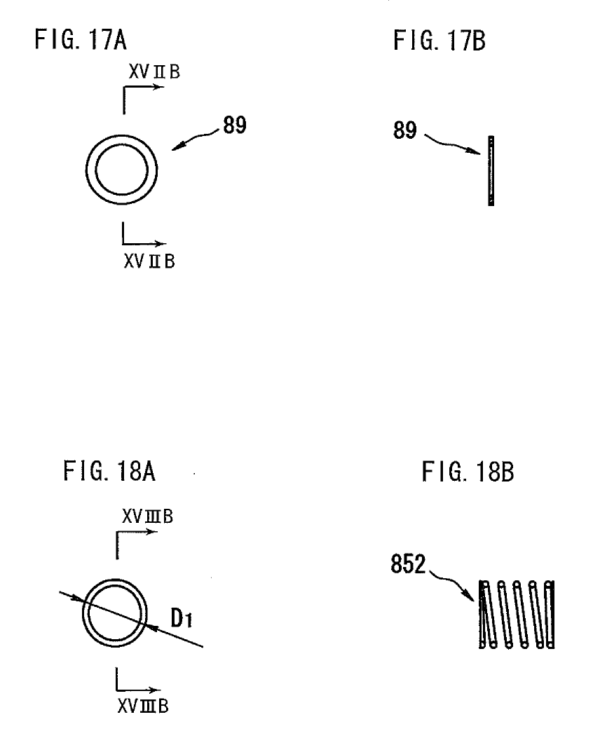

As shown in FIGS. 14, 16A, 16B, 24A, 24B, and 24C, the auxiliary spring 852 can be provided between the spring retainer 92c of the short push rod 92 and the annular portion 832b of the slide plate 832 in the clutch axial direction CA. Stated differently, the spring retainer 92c of the short push rod 92 can receive the left end of the auxiliary spring 852, and the annular portion 832b of the slide plate 832 can receive the right end of the auxiliary spring 852. According to the second exemplary embodiment, the left end of the auxiliary spring 852 can be abutted against the spring retainer 92c of the short push rod 92 through an annular plate 89 (see FIGS. 17A, B). In this way, the auxiliary spring 852 can push the short push rod 92 relative to the inner pipe 82 to the left in the clutch axial direction CA. Stated differently, the auxiliary spring 852 can push the inner pipe 822 to the right in the clutch axial direction CA relative to the short push rod 92 through the slide plate 832. As shown in FIGS. 18A and 18B, the auxiliary spring 852 can be, for example, a coil spring.

As shown in FIGS. 21A and 21B, the outer pipe 812 can have spiral screw grooves 812d and screw threads 812e at an inner circumferential surface. As shown in FIGS. 20A and 20B, the inner pipe 822 can have screw treads 822d and screw grooves 822e to be engaged with the screw grooves 812d and the screw threads 812e at an outer circumferential surface of the inner pipe 822.

As shown in FIGS. 14, 20A and 20B, the inner pipe 822 can have a pressurizing portion 822f abutted against the lock plate 842. The pressurizing portion 822f can be provided at the left end of the inner pipe 822. The pressurizing portion 822f can be provided at a backside of the spring retainer 822b in the clutch axial direction CA. The pressurizing portion 822f can pressurize the right side of the lock plate 842 when the short push rod 92 moves to the right in the clutch axial direction CA against the pushing force of the clutch spring 78.

As shown in FIGS. 14, 20A and 20B, the lock plate 842 can be provided between the pressurizing portion 92f of the short push rod 92 and the pressurizing portion 822f of the inner pipe 822 in the clutch axial direction CA. A spacer 88 can be provided between the pressurizing portion 92f of the short push rod 92 and the lock plate 842 in the clutch axial direction CA. More specifically, the lock plate 842 can be provided between the spacer 88 and the pressurizing portion 822f of the inner pipe 822 in clutch axial direction CA.

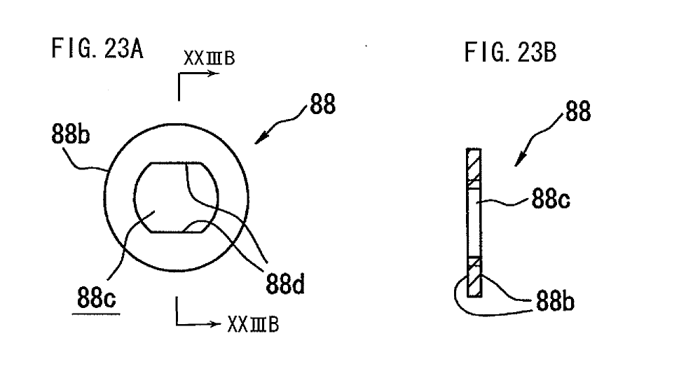

The spacer 88 can move relative to the short push rod 92 in the clutch axial direction CA and can be arranged so as to be substantially stationary relative to, e.g., not move relative to, the short push rod 92 around the main shaft 33. As shown in FIG. 23A, the spacer 88 can have a hole 88c formed therein. The upper and lower sides of the hole 88c can be formed so as to have a substantially flat or straight cut surface 88d. The cut surface 88d and the slide surface 92i of the short push rod 92 can be abutted against each other, so that the spacer 88 moves relative to the short push rod 92 in the clutch axial direction CA.

When the short push rod 92 moves more than the prescribed play amount to the right in the clutch axial direction CA against the pushing force of the auxiliary spring 852, in other words, in a disconnected state for the clutch 44, the lock plate 842 can restrict the relative movement of the outer pipe 812 and the inner pipe 822 in the clutch axial direction CA so that the outer pipe 812 and the inner pipe 822 move together with the short push rod 92 in the clutch axial direction CA.

As shown in FIGS. 22A and 22B, the lock plate 842 can be a plate member having an approximately annular shape. As shown in FIG. 22A, a plurality of claws 842a can be formed at an outer side of the lock plate 842. The claws 842a can extend outward in a radial direction. Moreover, as shown in FIG. 21A, the outer pipe 812 can have grooves 812c. The grooves 812c can extend from the left end to the right end when viewed from a side (see FIG. 21B). The claws 842a of the lock plate 842 can be fitted into the grooves 812c. In this way, the lock plate 842 can be arranged to move relative to the outer pipe 812 in the clutch axial direction CA, and so that the lock plate 842 does not rotate relative to the outer pipe 812 around the main shaft 33.

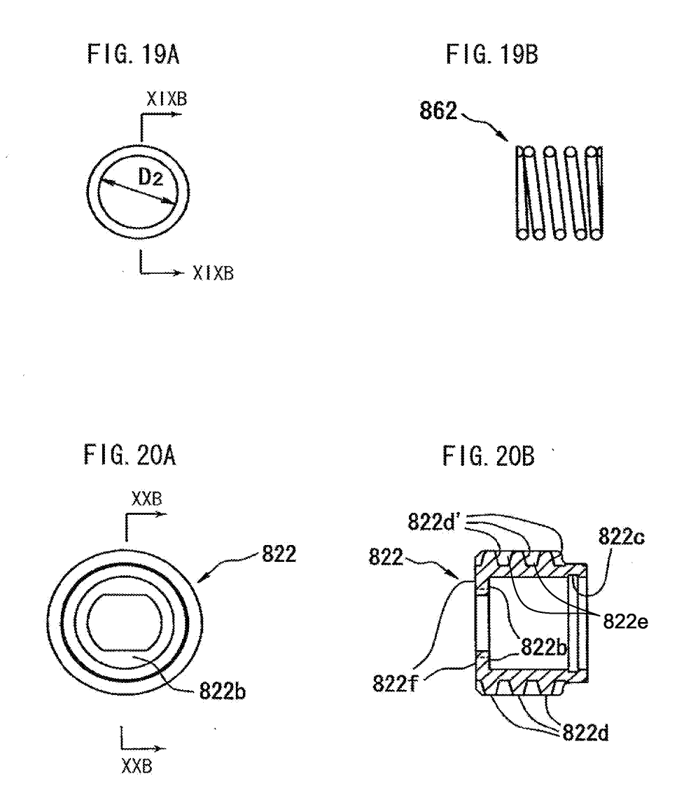

As shown in FIG. 14, the clutch 44 can be provided with the auxiliary spring 862 and the auxiliary spring 852. The auxiliary spring 862 can be provided coaxially with the auxiliary spring 852 in the clutch axial direction CA. Alternatively, the auxiliary spring 862 may be arranged in parallel with the auxiliary spring 852 in the clutch axial direction CA. As shown in FIGS. 19A and 19B, the auxiliary spring 862 can be, for example, a coil spring. As shown in FIGS. 18A and 19A, an inner diameter D2 of the auxiliary spring 862 can be greater than an outer diameter D1 of the auxiliary spring 852.

As described above, the inner pipe 822 can include the spring retainer 822b. The slide plate 832 can include the annular portion 832b. As shown in FIGS. 14, 19A, 19B, 16A, and 16B, the auxiliary spring 862 can be provided between the spring retainer 822b of the inner pipe 822 and the annular portion 832b of the slide plate 832 in the clutch axial direction CA. More specifically, the annular portion 832b of the slide plate 832 can receive the right end of the auxiliary spring 862.

The auxiliary spring 862 can fix the inner pipe 822 in a prescribed position in a clutch connected state. The auxiliary spring 862 can push the lock plate 842 from the right to the left through the spring retainer 822b when the lock spring 842 restricts the relative movement of the outer and inner pipes 812 and 822 in the clutch axial direction CA. Therefore, the lock plate 842 can be held between the annular portion 88b of the spacer 88 and the spring retainer 822b.

As shown in FIG. 14, the collar 872 is provided on the right of the auxiliary spring 862 and the slide plate 832 in the clutch axial direction CA. The collar 872 can have at least a part of its left end stored in the inner pipe 822. The collar 872 and the slide plate 83 can slide inside the inner pipe 822 when the short push rod 92 moves in the clutch axial direction CA.

In the power unit 3 according to the second exemplary embodiment, a part of the crankcase 31 on the inner side can include a projection 31p projecting to the left in the clutch axial direction CA. The projection 31p can have an approximately cylindrical shape. The collar 872 can be fitted into an inner circumferential portion of the projection 31p.

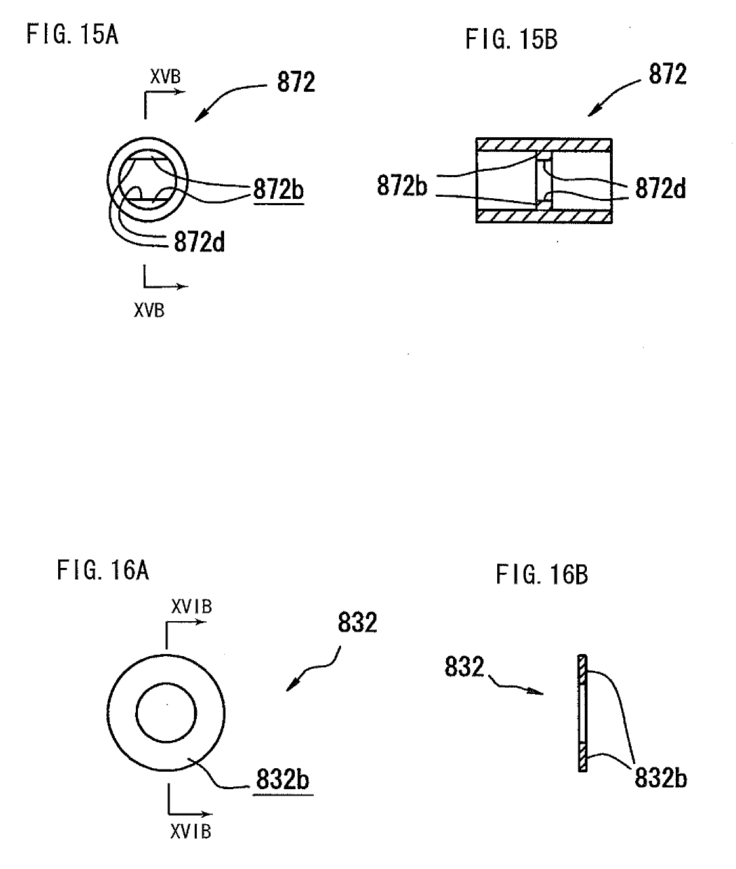

As shown in FIGS. 15A and 15B, the collar 872 can have an approximately cylindrical shape. A projection 872b and a cut surface 872d, each having a substantially straight or flat surface or edge, can extend radially inward from an inner circumferential portion of the collar 872. As shown in FIGS. 14, 15A, 15B, 24A, 24B, and 24C, the slide surface 92e of the short push rod 92 can be fitted to the projection 872b of the collar 872, and engaged with the cut surface 872d. As a result, at least the collar 872, the inner pipe 822, and the short push rod 92 can be arranged so as not to rotate relative to one another around the main shaft 33.

In the following, an exemplary operation of the automatic play adjusting mechanism 80 according to the second exemplary embodiment will be described. In a so-called clutch connected state, the pushing force of the auxiliary spring 852 can cause a gap to form between the left part of the lock plate 842 and the spacer 88 (see FIG. 14). The pushing force of the auxiliary spring 852 can cause a gap to form between the right part of the lock plate 842 and the pressurizing portion 822f (see FIG. 20) at the left end of the inner pipe 822. More specifically, in a clutch connected state, the lock plate 842 can be arranged so as not to abut against the pressurizing portion 92f (see FIG. 24) on the left and the pressurizing portion 822f (FIG. 20) of the inner pipe 822 on the right.

In this case or in a clutch connected state, there can be a gap both on the left and right between the screw grooves 812d (see FIG. 21B) of the outer pipe 812 and the screw threads 822d (see FIG. 20B) of the inner pipe 822. Therefore, the outer pipe 812 can move in the clutch axial direction CA relative to inner pipe 822 and rotate around the main shaft 33 relative to the inner pipe 822. In this way, when the plate group 66 thermally expands and the pressure plate 77 moves to the right in the clutch axial direction CA, the outer pipe 812 can rotate in a prescribed direction around the main shaft 33 relative to the inner pipe 822, and move to the right in the clutch axial direction CA (see FIG. 14). On the other hand, when the thermal expansion of the plate group 66 ends, the pressure plate 77 can move to the left in the clutch axial direction CA. When the plate group 66 wears, the pressure plate 77 can move to the left in the clutch axial direction CA. In this way, the outer pipe 812 can rotate in a direction to the prescribed direction relative to the inner pipe 822 around the main shaft 33, and move to the left in the clutch axial direction CA. This is because when the plate group 66 is affected by the heat, the pushing force of the auxiliary spring 862 can substantially prevent the inner pipe 822 from moving from the prescribed position in the clutch axial direction CA.

Moreover, the short push rod 92 can be substantially stationary relative to, e.g., not move relative to, the pressure plate 77 and the outer pipe 812 by the pushing force of the auxiliary spring 852 and the auxiliary spring 862 even when the plate group 66 thermally expands or wears. As described above, the pressure plate 77 and the outer pipe 812 can move together in the clutch axial direction CA through the bearing 51. More specifically, in a clutch connected state, when the plate group 66 thermally expands or wears, the outer pipe 812 can move relative to the short push rod 92 in the clutch axial direction CA. Therefore, the automatic play adjusting mechanism 80 can allow movement of the pressure plate 77 relative to the short push rod 92 in the clutch axial direction CA in a clutch connected state.

When the clutch release mechanism 96 (see FIG. 13) operates to move the short push rod 92 a prescribed distance to the right in the clutch axial direction CA from the clutch connected state, the relative movement of the outer and inner pipes 812 and 822 in the clutch axial direction CA can be restricted. At this time, the pressurizing portion 92f (see FIG. 24) of the short push rod 92 can abut against the left end surface of the spacer 88. As a result, the gap between the left portion of the lock plate 842 and the spacer 88 can be substantially eliminated. Moreover, at this time, the gap between the right portion of the lock plate 842 and the pressurizing portion 822f (see FIG. 20) on the left end of the inner pipe 822 can also be substantially eliminated. When the short push rod 92 moves a prescribed distance to the right in the clutch axial direction CA, and the relative movement of the outer and inner pipes 812 and 822 is restricted, the clutch 44 is in the touch point. More specifically, in the touch point for the clutch, the lock plate 842 can be pressed against the pressurizing portion 92f (see FIG. 24) of the short push rod 92 on the left and the pressurizing portion 822f (see FIG. 20) at the left end of the inner pipe 822 on the right.

In the touch point for the clutch 44, abutment surfaces 822d′ of the screw threads 822d (see FIG. 20B) of the inner pipe 822 in a clutch disconnected state can be abutted against abutment surfaces 812d′ of the screw grooves 812d (see FIG. 21B) of the outer pipe 812 in a clutch disconnected state. More specifically, the gap made between the screw grooves 812d (see FIG. 21B) of the outer pipe 812 and the screw threads 822d (see FIG. 20B) of the inner pipe 822 can e substantially eliminated. This can restrict the movement of the outer pipe 812 relative to the inner pipe 822 in the clutch axial direction CA and the rotation of the outer pipe 812 relative to the inner pipe 812 around the main shaft 33. As a result, when the short push rod 92 moves at least the prescribed play amount to the right in the clutch axial direction CA (in other words after the touch point), the outer and inner pipes 812 and 822, the lock plate 842, and the short push rod 92 can move together to the right in the clutch axial direction CA. As described above, the pressure plate 77 and the outer pipe 812 can move together in the clutch axial direction CA through the bearing 51. Therefore, when the short push rod 92 moves at least the prescribed play amount to the right in the clutch axial direction CA (in other words after the touch point), the movement of the pressure plate 77 relative to the short push rod 92 in the clutch axial direction CA can be restricted. More specifically, after the touch point, the pressure plate 77 and the short push rod 92 can move together to the right in the clutch axial direction CA. Additionally, after the touch point, the slide plate 832 and the collar 872 can move to the left in the clutch axial direction CA relative to the outer and inner pipes 812 and 822, the lock plate 842, and the short push rod 92.

When the short push rod 92 further moves a prescribed distance to the right from the touch point in the clutch 44 by the operation of the driving mechanism 96 (see FIG. 13), a clutch disconnected state can be reached. The pressure plate 77 and the short push rod 92 can move together to the right in the clutch axial direction CA from the touch point to the clutch disconnected state. The slide plate 832 and the collar 872 can move to the left in the clutch axial direction CA relative to the outer and inner pipes 812 and 822, the lock plate 842, and the short push rod 92 from the touch point to the clutch disconnected state.

As previously described, the clutch 44 according to the second exemplary embodiment can include the automatic play adjusting mechanism 80. The automatic play adjusting mechanism 80 can be interposed between the pressure plate 77 and the short push rod 92 and allow movement of the pressure plate 77 relative to the short push rod 92 in the clutch axial direction CA in a clutch connected state where the friction plate 64 and the clutch plate 65 are pressed against each other. The automatic play adjusting mechanism 80, moreover, can restrict the relative movement of the pressure plate 77 to the short push rod 92 in the clutch axial direction CA when the short push rod 92 moves more than the prescribed play amount to the right in the clutch axial direction CA from the clutch connected state.

Thermal expansion of the clutch 44 can cause the pressure plate 77 to be pushed by the plate group 66 to the right in the clutch axial direction CA, and the pressure plate 77 to move to the right in the clutch axial direction CA. However, in a clutch connected state, the pressure plate 77 can move relative to the short push rod 92 in the clutch axial direction CA due to the automatic play adjusting mechanism 80. More specifically, when the thermal expansion of the clutch 44 causes the friction plate 64 and the clutch plate 65 to have an increased size (e.g., thickness) in the clutch axial direction CA, the pressure plate 77 can move to the right in the clutch axial direction CA relative to the short push rod 92. When the thermal expansion of the clutch 44 causes the friction plate 64 and the clutch plate 65 to have an increased thickness, the position of the short push rod 92 in the clutch axial direction CA can be substantially unchanged. Therefore, the automatic play adjusting mechanism 80 can absorb the shift of the touch point caused by the thermal expansion of the clutch 44. Additionally, the position where the clutch 44 is disconnected is the position reached by the short push rod 92 after moving the prescribed play amount to the right in the clutch axial direction CA. The position can be substantially unchanged if the thermal expansion of the clutch 44 causes the pressure plate 77 to move to the right in the clutch axial direction CA. More specifically, the disconnection start position for the clutch 44, in other words, the position of the touch point, can be substantially unchanged if the clutch 44 thermally expands. Therefore, with the clutch 44 according to the second exemplary embodiment, the shift of the touch point caused by thermal expansion can be reduced.

With the clutch 44 according to the second exemplary embodiment, when the thickness of the friction plate 64 or the clutch plate 65 is reduced because of wear, the pressure plate 77 can be moved to the left in the clutch axial direction CA by the pushing force of the clutch spring 78. In a clutch connected state, however, the pressure plate 77 can move relative to the short push rod 92 due to the automatic play adjusting mechanism 80 in the clutch axial direction CA. More specifically, when the thickness of the friction plate 64 or the clutch plate 65 is reduced by wear, the pressure plate 77 can move to the left in clutch axial direction CA relative to the short push rod 92. The position of the short push rod 92 in the clutch axial direction CA can be substantially unchanged when the thickness of the friction plate 64 or the clutch plate 65 is reduced. Therefore, the automatic play adjusting mechanism 80 can absorb the shift of the touch point when the thickness of the friction plate 64 or the clutch plate 65 is reduced by wear. Moreover, the position where the clutch 44 is disconnected corresponds to the position reached by the short push rod 92 after moving the prescribed play amount to the right in the clutch axial direction CA. The position can be substantially unchanged when the pressure plate 77 moves to the left in the clutch axial direction CA by the wear of the plate group 66. More specifically, when the thickness of the friction plate 64 or the clutch plate 65 is reduced because of the wear, the disconnection start position for the clutch 44, in other words, the position of the touch point, can be substantially unchanged. Therefore, the clutch 44 according to the second exemplary embodiment can allow the shift of the touch point caused by the wear of the plate group 66 to be reduced.

### Third Exemplary Embodiment

According to each of the embodiments described above, the clutch 44 can respond to the operation of the clutch lever 24 by the rider of the motorcycle 1 and the pressurized state of the plate group 66 can forcibly released. However, the clutch 44 may include an actuator. More specifically, the clutch 44 according to the third exemplary embodiment can be disconnected in response to the operation of the actuator. The clutch 44 can be disconnected in response to the manual operation of the clutch lever 24 (see FIG. 1) by the rider or the operation of the actuator. In the following description, elements having the same effects as those described with reference to the first and second exemplary embodiments are designated by the same reference characters used for the elements in the previous description, and their detailed description is omitted for conciseness.

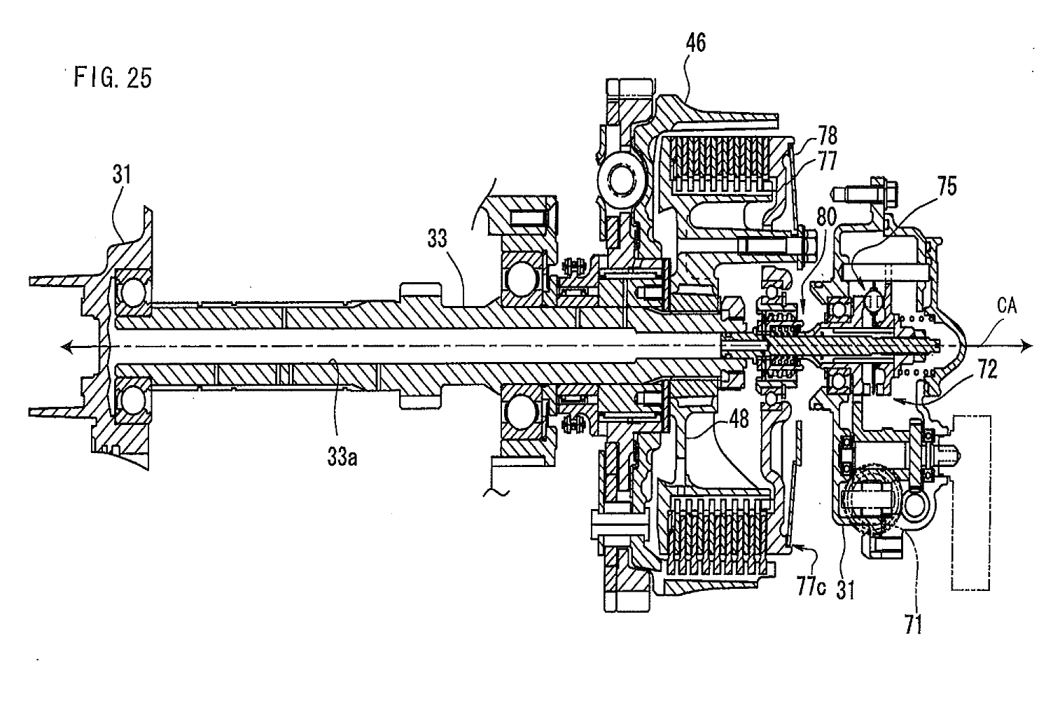

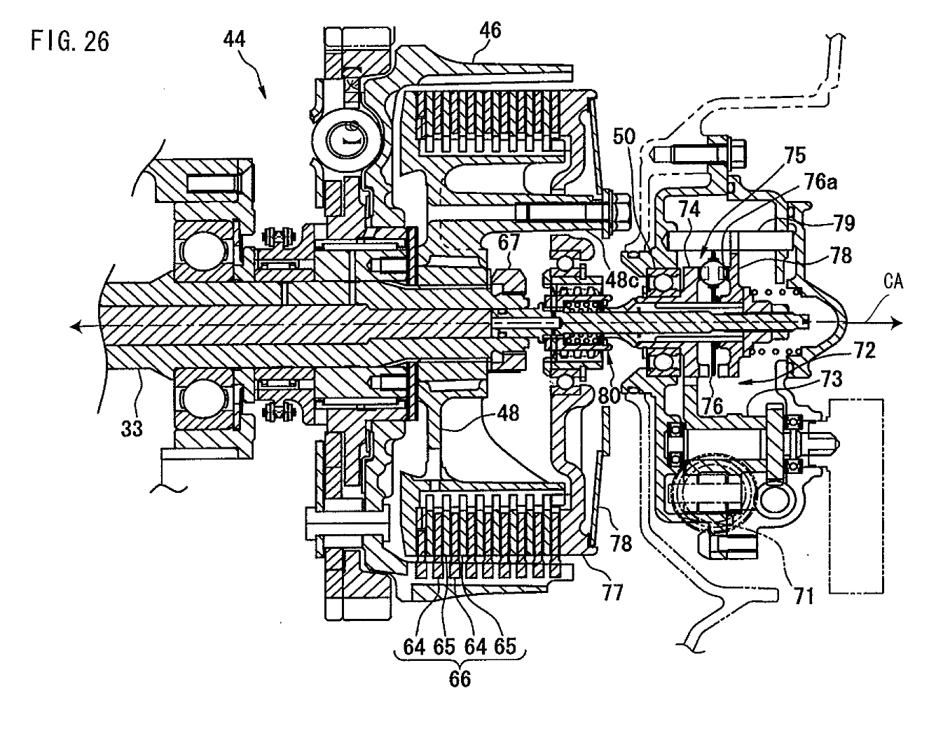

As shown in FIG. 25 or 26, the power unit 3 (see FIG. 2) can include a clutch actuator 71 arranged to disconnect the clutch 44. The pressure plate 77 can move in the clutch axial direction CA in response to the driving of the clutch actuator 71. When the clutch 44 is connected, a rod 95 can move to the left in FIG. 25 and the pressure plate 77 can also move to the left. As a result, the pressure plate 77 can cause the friction plate 64 and the clutch plate 65 to be pressed against each other upon receiving the pushing force of the clutch spring 78. In this way, the clutch 44 can attain a clutch connected state.

On the other hand, when the clutch 44 is disconnected, the rod 95 can move to the right in FIG. 25, and the pressure plate 77 can move to the right in FIG. 25 against the pushing force of the clutch spring 78. As a result, the friction plate 64 and the clutch plate 65 can be released from the pressurized contacted state, so that the clutch 44 attains a clutch disconnected state.

In this way, depending on the magnitude of the driving force of the clutch actuator 71 and the pushing force of the clutch spring 78, the pressure plate 77 can move to one side or the other side in the clutch axial direction CA, and the clutch 44 can be connected or disconnected in response to the movement.

The clutch actuator 71 can be driven by the rider of the motorcycle 1 when an automatic transmission operation switch is operated. The automatic transmission operation switch can be provided in a position easily operable by the rider, for example at the handle 12 (see FIG. 1). When the automatic transmission operation switch is operated, a control unit (not shown) for the motorcycle 1 can control the clutch actuator 71, so that a series of operation for disconnection and connection for the clutch 44 is carried out.

As shown in FIG. 25, the clutch 44 can be disconnected by the operation of an operation force transmission mechanism 72 coupled to the clutch actuator 71. The operation force transmission mechanism 72 can include a rotor 73 coupled to the clutch actuator 71, a rotor 74 engaged with the rotor 73, and a ball cam 75 arranged to convert the rotation force of the rotor 74 into force in the axial direction of the rod 95. The rotor 74 can form a part of the ball cam 75 according to the third exemplary embodiment. However, the rotor 74 may be discrete from the ball cam 75. The ball cam 75 can include a cam plate 78, a ball plate 76, and the rotor 74.

The cam plate 78 can be fixed to the rod 95. Therefore, the cam plate 78 can move in the axial direction of the rod 95 together with the rod 95. The cam plate 78, however, can have its rotation around the rod 95 restricted by a stopper pin 79. The stopper pin 79 can be attached at the crankcase 31.

The ball plate 76 can support three balls 76a arranged at equal intervals in the circumferential direction so that they can roll. The number of the balls 76a is not limited to three.

The rotor 74 can be supported rotatably around the rod 95 by a bearing 50. Moreover, the rotor 74 can be arranged so that it does not move in the axial direction of the rod 95.

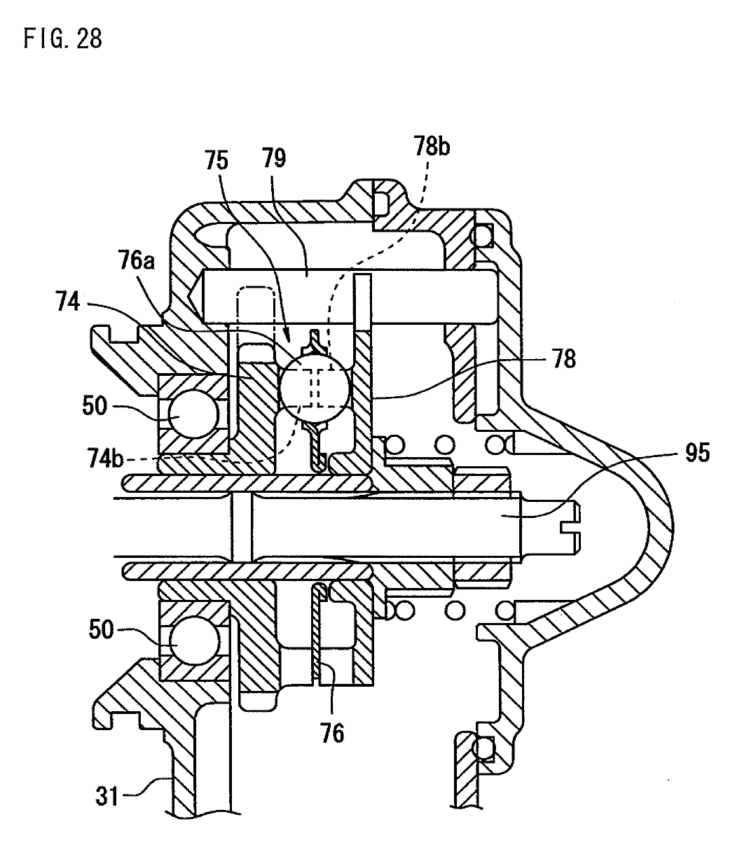

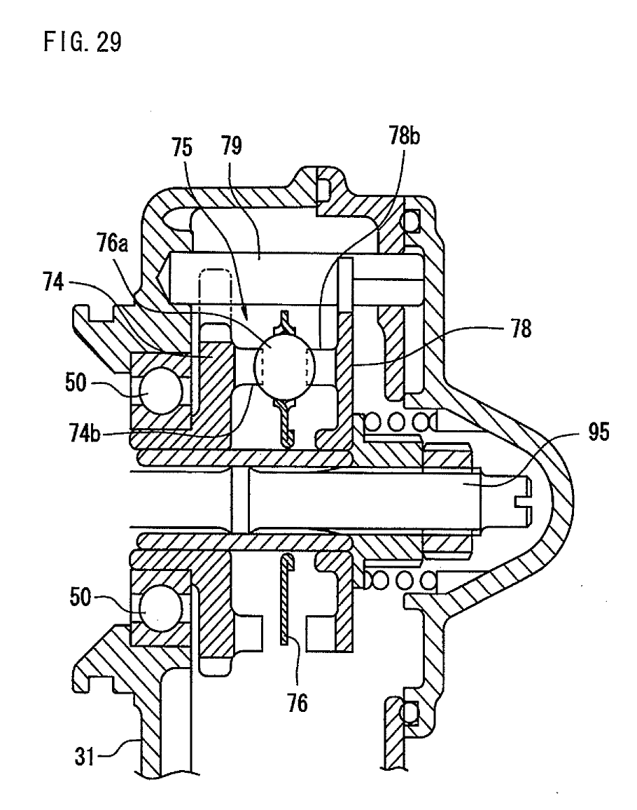

As shown in FIG. 28, a cam groove 78b and a cam groove 74b inclined along the circumference can be formed at a surface on the left side of the cam plate 78 and a surface on the right side of the rotor 74, respectively. In this way, according to the third exemplary embodiment, the rotor 74 can also function as a cam plate. When the rotor 74 rotates, the relative position between the cam groove 78b of the cam plate 78 and the cam groove 74b of the rotor 74 can be shifted, and the balls 76a can be raised off of the cam grooves 78b and 74b. In this way, the cam plate 78 can be pushed to the right by the ball 76a, and slide to the right (see FIG. 29). The rod 95 can slide to the right and the pressure plate 77 can move to the right accordingly. As a result, the clutch 44 can be switched from the connected state to the disconnected state.

Next, an exemplary operation of disconnecting and connecting the clutch 44 by the clutch actuator 71 will be described. When the clutch actuator 71 is driven, the rotor 73 can rotate in a prescribed direction around the main shaft 33. Since the rotor 73 and the rotor 74 are engaged with each other, as the rotor 73 rotates in a prescribed direction, the rotor 74 can rotate in a direction the reverse of the prescribed direction.

When the clutch actuator 71 is further driven from the disconnection start position for the clutch 44, the rotor 73 can further rotate in the prescribed direction. As the rotor 73 rotates, the rotor 74 can further rotate in the direction the reverse of the prescribed direction. Then, the ball 76a of the ball plate 76 of the ball cam 75 can be slightly raised off the cam groove 78b of the cam plate 78 and the cam groove 74b of the rotor 74. As a result, the cam plate 78 can be pushed out by the ball 76a in the direction to disconnect the clutch 44. More specifically, the cam plate 78 can be pushed to the right in the clutch axial direction CA and move to the right together with the rod 95. In this way, the pressure plate 77 can move to the right and the clutch 44 is disconnected. When the clutch 44 changes in a disconnected state to in a connected state, an operation opposite to the above-described operation can be carried out.

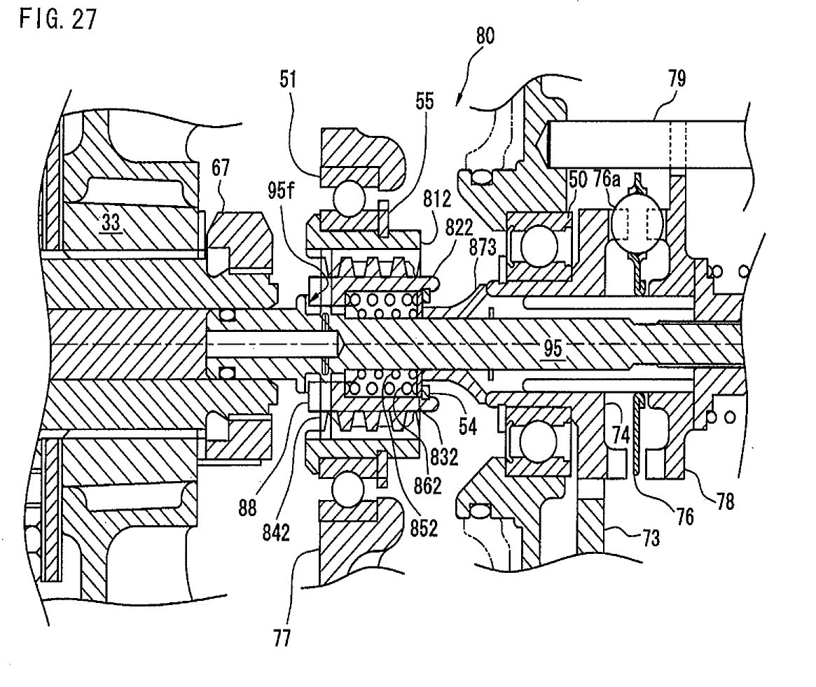

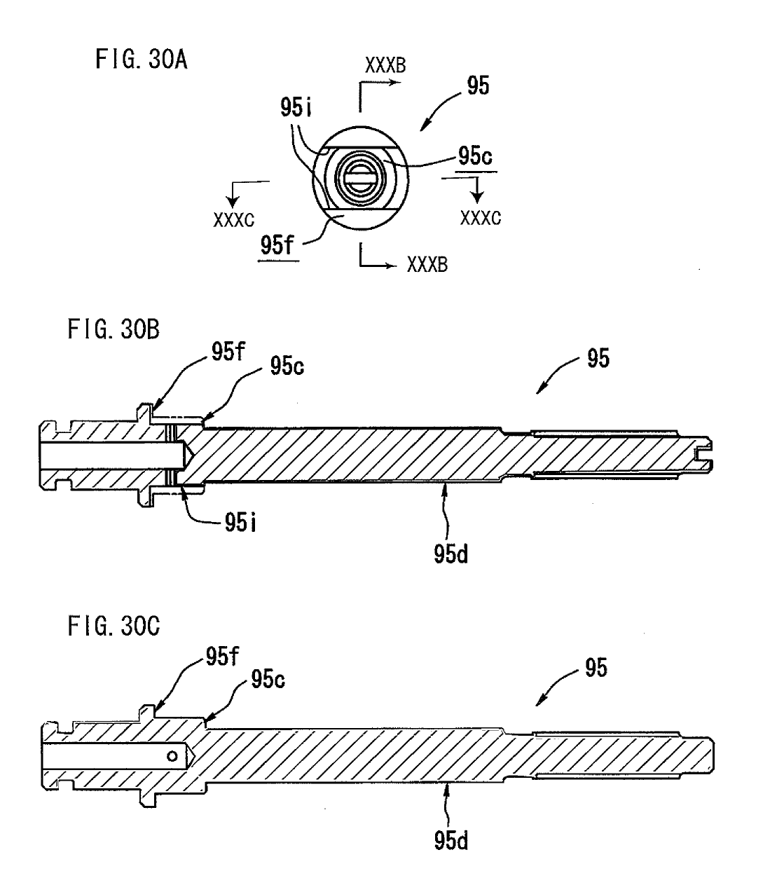

As shown in FIGS. 30A to 30C, the rod 95 can include a shaft portion 95d, a spring retainer 95c, and a pressurizing portion 95f. The shaft portion 95d can extend approximately parallel to the axial direction of the main shaft 33 (see, e.g., FIG. 26). The spring retainer 95c can be a part of the shaft portion 95d having a comparatively large outer diameter. The pressurizing portion 95f can be formed at the shaft portion 95d and extend in a flange shape radially outward on the left of the spring retainer 95c. A slide surface 95i can be formed to have a substantially flat shape between the pressurizing portion 95f and the spring retainer 95c of the shaft portion 95d in the clutch axial direction CA. The lock plate 842 (see FIG. 27), the spacer 88 (see FIG. 27), and a part of the inner pipe 822 can move in the clutch axial direction CA relative to the rod 95 at the slide surface 95i. The part of the shaft portion 95d on the right of the pressurizing portion 95f can penetrate or extend through the lock plate 842, the auxiliary spring 852, the auxiliary spring 862, the slide plate 832, the collar 873, and the inner pipe 822 in the clutch axial direction CA.

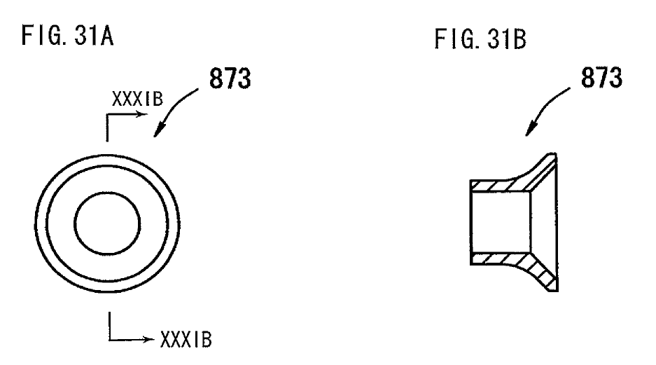

As shown in FIG. 27, the collar 873 can be provided on the right of the auxiliary spring 862 and the slide plate 832 in the clutch axial direction CA. As shown in FIGS. 31A and 31B, the collar 873 can have an approximately cylindrical shape. At least a part of the left end of the collar 873 can be stored in the inner pipe 822. The rod 95 can penetrate or extend through the collar 873. The collar 873 and the slide plate 83 can slide in the inner pipe 822 when the rod 95 moves in the clutch axial direction CA.

As described above, the cam plate 78 can be fixed to the rod 95 and can move in the axial direction of the rod 95 together with the rod 95. The cam plate 78 can have its rotation around the rod 95 restricted by a stopper pin 79. The stopper pin 79 can be attached at the crankcase 31. In this way, the rod 95 can have its rotation around the shaft restricted.

Next, an exemplary operation of the automatic play adjusting mechanism 80 according to the third exemplary embodiment will be described. In a so-called clutch connected state, a gap can be formed between the left part of the lock plate 842 and the spacer 88 by the pushing force of the auxiliary spring 852 (see FIG. 27). A gap can also be formed between the right part of the lock plate 842 and the pressurizing portion 822f (see FIG. 20) at the left end of the inner pipe 822 by the pushing force of the auxiliary spring 852. More specifically, in a clutch connected state, the lock plate 842 can be arranged so as not to be pressed between the pressurizing portion 95f (see FIGS. 30A to 30C) of the rod 95 and the pressurizing portion 822f (FIG. 20) of the inner pipe 822.

When the rod 95 moves a prescribed play amount to the right in the clutch axial direction CA from the clutch connected state by the driving of the clutch actuator 71, this can restrict the relative movement of the outer pipe 812 and the inner pipe 822 in the clutch axial direction CA. At this time, the pressurizing portion 95f (see FIGS. 30A to 30C) of the rod 95 can abut against the left end surface of the spacer 88. As a result, the gap between the left part of the lock plate 842 and the spacer 88 can be substantially eliminated. Further, as this time, the gap between the right part of the lock plate 842 and the pressurizing portion 822f (see FIG. 20) of the inner pipe 822 can also be substantially eliminated. When the rod 95 moves a prescribed play amount to the right in the clutch axial direction CA and the relative movement of the outer pipe 812 and the inner pipe 822 in the clutch axial direction CA is restricted, the clutch 44 is in the touch point. In the touch point for the clutch 44, the lock plate 842 can be pressed between the pressurizing portion 95f of the rod 95 and the pressurizing portion 822f (see FIG. 20) of the inner pipe 822.

When the rod 95 moves more than the prescribed play amount to the right in the clutch axial direction CA (e.g., after the touch point), the relative movement of the pressure plate 77 to the rod 95 in the clutch axial direction CA can be restricted. More specifically, after the touch point, the pressure plate 77 and the rod 95 can move together to the right in the clutch axial direction CA. After the touch point, the slide plate 832 and the collar 873 can move to the left in the clutch axial direction CA relative to the outer pipe 812, the inner pipe 822, the lock plate 842, and the rod 95.

When the rod 95 further moves a prescribed distance to the right in the clutch axial direction CA from the touch point for the clutch 44 by the driving of the touch actuator 71, a clutch disconnected state can be attained. The pressure plate 77 and the rod 95 can move together to the right in the clutch axial direction CA after the touch point until a clutch disconnected state is attained. The slide plate 830 and the collar 873 can move to the left in the clutch axial direction CA relative to the outer pipe 812, the inner pipe 822, the lock plate 842, and the rod 95.

As described previously, the clutch 44 according to the third exemplary embodiment can include an automatic play adjusting mechanism 80. The automatic play adjusting mechanism 80 can be interposed between the pressure plate 77 and the rod 95, and in a clutch connected state where the friction plate 64 and the clutch plate 65 are pressed against each other, the pressure plate 77 can be allowed to move relative to the rod 95 in the clutch axial direction CA. The automatic play adjusting mechanism 80 can restrict the movement of the pressure plate 77 relative to the rod 95 in the clutch axial direction CA when the rod 95 moves more than the prescribed play amount to the right in the clutch axial direction CA from the clutch connected state.

When the clutch 44 according to the third exemplary embodiment is thermally expanded, the pressure plate 77 can be pushed to the right in the clutch axial direction CA by the plate group 66, and the pressure plate 77 can move to the right in the clutch axial direction CA. In a clutch connected state, however, the pressure plate 77 can move relative to the rod 95 in the clutch axial direction CA due to the automatic play adjusting mechanism 80. More specifically, if the thermal expansion of the clutch 44 increases the size (e.g., thickness) of the friction plate 64 and the clutch plate 65 in the clutch axial direction CA, the pressure plate 77 can move relative to the rod 95 to the right in the clutch axial direction CA. The position of the rod 95 can be substantially unchanged in the clutch axial direction CA if the thickness of the friction plate 64 and the clutch plate 65 increases by the thermal expansion of the clutch 44. As a result, the automatic play adjusting mechanism 80 can absorb the shift of the touch point caused by the thermal expansion of the clutch 44 when the clutch 44 is thermally expanded. The clutch 44 can be disconnected in the position reached by the rod 95 after moving the prescribed play distance to the right in the clutch axial direction CA. The position can be substantially unchanged when the pressure plate 77 moves to the right in the clutch axial direction CA by the thermal expansion of the clutch 44. More specifically, when the clutch 44 is thermally expanded, the disconnection start position for the clutch 44, in other words, the position of the touch point, can be substantially unchanged. Therefore, with the clutch 44 according to the third exemplary embodiment, the shift of the touch point caused by the thermal expansion can be reduced.

With the clutch 44 according to the third exemplary embodiment, when the thickness of the friction plate 64 or the clutch plate 65 is reduced because of wear, the pressure plate 77 can move to the left in the clutch axial direction CA by the pushing force of the clutch spring 78. However, in a clutch connected state, the pressure plate 77 can move relative to the rod 95 in the clutch axial direction CA due to the automatic play adjusting mechanism 80. When the thickness of the friction plate 64 or the clutch plate 65 is reduced because of wear, the pressure plate 77 can move to the left in the clutch axial direction CA relative to the rod 95. The position of the rod 95 in the clutch axial direction CA can be substantially unchanged when the thickness of the friction plate 64 or the clutch plate 65 is reduced. As a result, the automatic play adjusting mechanism 80 can absorb the shift of the touch point if the thickness of the friction plate 64 or the clutch plate 65 is reduced because of wear. The clutch 44 can be disconnected in the position reached by the rod 95 after moving the prescribed play amount to the right in the clutch axial direction CA. The position can be substantially unchanged when the thickness of the friction plate 64 or the clutch plate 65 is reduced because of wear. In other words, when the thickness of the friction plate 64 or the clutch plate 65 is reduced because of wear, the disconnection start position for the clutch 44 or the position of the touch point can be substantially unchanged. Therefore, with the clutch 44 according to the third exemplary embodiment, the shift of the touch point caused by the wear of the plate group 66 can be reduced.

It will be apparent to one skilled in the art that the manner of making and using the claimed invention has been adequately disclosed in the above-written description of the exemplary embodiments taken together with the drawings. Furthermore, the foregoing description of the embodiments according to the invention is provided for illustration only, and not for limiting the invention as defined by the appended claims and their equivalents.

It will be understood that the above description of the exemplary embodiments of the invention are susceptible to various modifications, changes and adaptations, and the same are intended to be comprehended within the meaning and range of equivalents of the appended claims.

1. A clutch having a connected state and a disconnected state, comprising:
a main shaft arranged along a prescribed clutch axial direction;
a friction plate supported rotatably around the main shaft to rotate according to a rotation of a crankshaft;
a clutch plate supported around the main shaft and opposed to the friction plate, the clutch plate to rotate together with the main shaft;
a rod arranged along the clutch axial direction and moved to one side in the clutch axial direction in the disconnected state;
a pressure plate supported rotatably around the rod;
a clutch spring arranged to push the pressure plate to the other side in the clutch axial direction so that the friction plate and the clutch plate are rubbed against each other; and
an automatic play adjusting mechanism provided between the pressure plate and the rod to allow the pressure plate to move relative to the rod in the clutch axial direction in the connected state and restrict the movement of the pressure plate relative to the rod in the clutch axial direction in the disconnected state.

2. The clutch according to claim 1, wherein the automatic play adjusting mechanism comprises:
an inner pipe mounted around the rod;
an outer pipe mounted around the inner pipe to support the pressure plate; and
a lock member arranged to restrict movement of the inner and outer pipes relative to the rod in the clutch axial direction in the disconnected state.

3. The clutch according to claim 2, wherein the automatic play adjusting mechanism further comprises:
a first auxiliary spring arranged to push the inner pipe relative to the rod to one side in the clutch axial direction; and
a second auxiliary spring arranged to push the inner pipe relative to the rod to the other side in the clutch axial direction.

4. The clutch according to claim 3, wherein
the outer pipe comprises a screw groove and a screw thread on an inner circumferential surface thereof, and
the inner pipe comprises a screw thread and a screw groove engaged with the screw groove and the screw thread of the outer pipe on an outer circumferential surface of the inner pipe.

5. The clutch according to claim 4, wherein
the rod comprises a first pressurizing portion,
the inner pipe comprises a second pressurizing portion opposed to the first pressurizing portion, and
the lock member comprises a lock plate arranged between the first and second pressurizing portions and attached unrotatably relative to the outer pipe and movably in the clutch axial direction.

6. The clutch according to claim 3, wherein:
the rod comprises a first spring retainer arranged to receive one end of the first auxiliary spring;
the inner pipe comprises
a second spring retainer arranged to receive the other end of the first auxiliary spring, and
a third spring retainer arranged to receive one end of the second auxiliary spring; and
the clutch further comprises
a slide plate attached movably relative to the rod in the clutch axial direction, and
the slide plate comprises a fourth spring retainer arranged to receive the other end of the second auxiliary spring.

7. The clutch according to claim 3, wherein:
the rod comprises a fifth spring retainer arranged to receive one end of the first auxiliary spring;
the inner pipe comprises a sixth spring retainer arranged to receive one end of the second auxiliary spring; and
the clutch further comprises
a slide plate attached movably relative to the rod in the clutch axial direction, and
the slide plate comprises a seventh spring retainer arranged to receive the other ends of the first and second auxiliary springs.

8. The clutch according to claim 2, further comprising:
a bearing provided between the pressure plate and the outer pipe, the pressure plate being supported rotatably by the outer pipe through the bearing.

9. The clutch according to claim 1, wherein
the rod comprises a pull rod arranged on one side of the main shaft and substantially coaxially with the main shaft,
the clutch further comprising a clutch release mechanism arranged to pull the pull rod in the disconnected state.

10. The clutch according to claim 1, wherein the main shaft comprises a through hole arranged to extend in the clutch axial direction, and
the rod comprises a push rod inserted in the through hole, the push rod having one end projected from the main shaft,
the clutch further comprising:
a clutch release mechanism arranged to push the push rod in the disconnected state.

11. The clutch according to claim 1, further comprising:
a clutch housing supported rotatably around the main shaft and arranged to support the friction plate; and
a clutch boss supported by the main shaft to rotate together with the main shaft and arranged to support the clutch plate.

12. The clutch according to claim 1, wherein
a plurality of the friction plates and a plurality of the clutch plates are arranged so as alternate with one another.

13. A power unit, comprising:
an engine;
a transmission device arranged to change an engine speed of the engine; and
a clutch provided between the engine and the transmission device and having a connected state in which power is transmitted from the engine to the transmission device and a disconnected state in which power is not transmitted,
the clutch comprising
a main shaft provided along a clutch axial direction,
a friction plate supported rotatably around the main shaft to rotate according to a rotation of a crankshaft,
a clutch plate supported around the main shaft and opposed to the friction plate, the clutch plate to rotate together with the main shaft,
a rod arranged along the clutch axial direction and moved to one side in the clutch axial direction in the disconnected state,
a pressure plate supported rotatably around the rod,
a clutch spring arranged to bias the pressure plate to the other side in the clutch axial direction so that the friction plate and the clutch plate are pressed against each other; and
an automatic play adjusting mechanism provided between the pressure plate and the rod to allow the pressure plate to move relative to the rod along the clutch axial direction in the connected state and restrict the movement of the pressure plate relative to the rod along the clutch axial direction in the disconnected state.

14. A vehicle, comprising:
an engine;
a transmission device arranged to change the engine speed of the engine; and
a clutch provided between the engine and the transmission device and having a connection state in which power is transmitted from the engine to the transmission device and a disconnected state in which power is not transmitted;
the clutch comprising
a main shaft arranged along a prescribed clutch axial direction,
a friction plate supported around the main shaft to rotate according to a rotation of a crankshaft,
a clutch plate supported by the main shaft and opposed to the friction plate, the clutch plate and the friction plate to rotate together with the main shaft,
a rod arranged along the clutch axial direction and moved to one side in the clutch axial direction in the disconnected state,
a pressure plate supported rotatably around the rod,
a clutch spring arranged to push the pressure plate to the other side in the clutch axial direction so that the friction plate and the clutch plate are rubbed against each other, and
an automatic adjusting mechanism provided between the pressure plate and the rod to allow the pressure plate to move relative to the rod in the clutch axial direction in the connected state and restrict the pressure plate to move relative to the rod along the clutch axial direction in the disconnected state.

15. The vehicle according to claim 14, further comprising:
a clutch operator for operation by a driver and arranged to move the rod against the pushing force of the clutch spring.
